(19) United States
(12) Patent Application Publication
(10) Pub. No.: US 2026/0128621 A1
(43) Pub. Date: May 7, 2026

(54) COMMUNICATION PROTOCOL IN A WIRELESS POWER SYSTEM

(71) Applicant: Dolby Intellectual Property Licensing, LLC, San Francisco, CA (US)

(72) Inventors: Jayanti Ganesh, Bangalore (IN); Viswanathan Kanakasabai, Bangalore (IN); Subbarao Tatikonda, Bangalore (IN); Suma Memana Narayana Bhat, Bangalore (IN)

(21) Appl. No.: 19/119,479

(22) PCT Filed: Oct. 12, 2023
(86) PCT No.: PCT/US2023/076641

§ 371 Date: Apr. 9, 2025

(30) Foreign Application Priority Data
Oct. 12, 2022 (IN) 202211058356

(51) Int. Cl. H02J 50/80; H02J 50/10; H02J 50/90

(52) U.S. Cl. CPC H02J 50/80; H02J 50/10; H02J 50/90

(57) ABSTRACT

This disclosure provides systems, methods and apparatuses for communication protocol enhancements in a wireless power system. Various implementations relate generally to messages for a communication protocol in a wireless power system. The communication protocol and related aspects address unexpected conditions of a Power Transmitter or a Power Receiver in a wireless power system.

### TECHNICAL FIELD

This disclosure relates generally to wireless power. Some aspects of this application relate communication for power negotiation, power control, and fault handling in a wireless power system.

### DESCRIPTION OF RELATED TECHNOLOGY

A wireless power system may include a Power Transmitter and a Power Receiver. For example, the Power Transmitter may be installed on or included in a countertop or other flat surface. The Power Receiver may be included in a cordless appliance, such as a blender, a kettle, an air fryer, a mixer, or a toaster, among other examples. The Power Transmitter may include a primary coil that produces an electromagnetic field that may induce a voltage in a secondary coil of the Power Receiver when the secondary coil is placed in proximity to the primary coil. In this configuration, the electromagnetic field may wirelessly transfer power to the secondary coil. The power may be transferred using inductive coupling or resonant coupling between the primary coil and the secondary coil. The Power Receiver may provide the received power to operate the cordless appliance.

### SUMMARY

The systems, methods, and apparatuses of this disclosure each have several innovative aspects, no single one of which is solely responsible for the desirable attributes disclosed herein.

In one innovative aspect, a method may include setting a PTx minimum supported power level of the Power Transmitter, where the PTx minimum supported power level is based on a measurement and processing capability of the Power Transmitter.

In one innovative aspect, the subject matter described in this disclosure can be implemented as a method. The method may include transferring power from the Power Transmitter to a Power Receiver during a power transfer phase after a first power negotiation. Method may also include receiving a power control message from the Power Receiver. Method may furthermore include determining that the power control message indicates a requested power level that would cause the Power Transmitter to exceed a current or power limit of the Power Transmitter or that the Power Transmitter cannot satisfy a Guaranteed Power established in the first power negotiation. Method may in addition include transitioning from the power transfer phase to a connected phase.

In one innovative aspect, the subject matter described in this disclosure can be implemented as a method. The method may include performing a power negotiation with a Power Receiver during a connected phase. Method may also include receiving a negotiation value request message from the Power Receiver. Method may furthermore include communicating a suggested negotiation value to the Power Receiver in response to the negotiation value request message.

In one innovative aspect, the subject matter described in this disclosure can be implemented as a method. The method may include obtaining a communication message from a Power Receiver, where the communication message includes a status field indicating status of the Power Receiver.

In one innovative aspect, the subject matter described in this disclosure can be implemented as a method. The method may include transferring power to a Power Receiver during a power transfer phase. Method may also include detecting a misalignment condition causing the Power Transmitter to operate above a PTx limit or preventing the Power Transmitter from satisfying a Guaranteed Power at the PTx limit.

In one innovative aspect, the subject matter described in this disclosure can be implemented as a method. The method may include adjusting, during a power transfer phase with a Power Receiver, a communication carrier level of a communication signal.

In one innovative aspect, the subject matter described in this disclosure can be implemented as a method. The method may include communicating a power control message to a Power Transmitter during a power transfer phase, where the power control message indicates a requested power level. Method may also include determining that the Power Transmitter has transitioned from the power transfer phase to a connected phase due to the requested power level being less than the PTx minimum supported power level.

In one innovative aspect, the subject matter described in this disclosure can be implemented as a method. The method may include receiving power from a Power Transmitter during a power transfer phase after a first power negotiation. Method may also include communicating a power control message to the Power Transmitter. Method may furthermore include receiving a phase transition message from the Power Transmitter indicative that a requested power level that would cause the Power Transmitter to exceed a current or power limit of the Power Transmitter or that the Power Transmitter cannot satisfy a Guaranteed Power established in the first power negotiation. Method may in addition include transitioning from the power transfer phase to a connected phase.

In one innovative aspect, the subject matter described in this disclosure can be implemented as a method. The method may include performing a power negotiation with a Power Transmitter during a connected phase. Method may also include communicating a negotiation value request message to the Power Transmitter. Method may furthermore include receiving a suggested negotiation value from the Power Transmitter in response to the negotiation value request message.

In one innovative aspect, the subject matter described in this disclosure can be implemented as a method. The method may include communicating a communication message to a Power Transmitter, where the communication message includes a status field indicating status of the Power Receiver.

In one innovative aspect, the subject matter described in this disclosure can be implemented as a method. The method may include receiving a wireless power signal from a Power Transmitter during a power transfer phase. Method may also include communicating a control message or phase transition message to the Power Transmitter. Method may furthermore include determining that the Power Transmitter has not processed the control message or the phase transition message within an expected time period. Method may in addition include initiating a mitigation technique associated with communication fault of the wireless power system.

### BRIEF DESCRIPTION OF THE DRAWINGS

FIG. 1 shows a block diagram of an example wireless power system that includes an example Power Transmitter and an example Power Receiver.

FIG. 2 shows a message flow diagram of an example wireless power transmission process.

FIG. 3 shows a block diagram conceptually illustrating an example Power Transmitter.

FIG. 4 shows a block diagram conceptually illustrating an example Power Receiver.

FIG. 5 shows a block diagram conceptually illustrating an example power negotiation and control.

FIG. 6 shows a block diagram conceptually illustrating a communication protocol.

FIG. 7 shows an example message flow diagram conceptually illustrating an example communication enhancement.

FIG. 8 shows a message flow diagram conceptually illustrating an example power negotiation.

FIG. 9 shows an example communication technique for a Power Receiver to indicate status.

FIG. 10 shows a message flow diagram conceptually illustrating an example communication technique for addressing a misalignment during a power transfer phase.

FIG. 11 shows a diagram of a communication carrier voltage being adjusted during a power transfer phase.

FIG. 12 shows a message flow diagram conceptually illustrating an example technique for addressing a communication fault during a power transfer phase.

FIGS. 13-18 include flowcharts of example processes of a Power Transmitter.

FIG. 19-23 include flowcharts of example processes of a Power Receiver.

FIG. 24 shows a block diagram of an example apparatus for use in wireless power system.

Note that the relative dimensions of the figures may not be drawn to scale.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system may include a Power Transmitter (sometimes also referred to as a PTx or a wireless power transmission apparatus) integrated with or otherwise disposed on a surface. The wireless power system also may include a Power Receiver (sometimes also referred to as a PRx or a wireless power reception apparatus). The Power Transmitter may include a primary coil configured to wirelessly transmit power via a magnetic field to a secondary coil in the Power Receiver. In some implementations, the Power Transmitter may include a countertop-mounted primary coil or a primary coil that is embedded or manufactured in a surface on which a cordless appliance can be placed. The cordless appliance may include a Power Receiver for wirelessly receiving power. A secondary coil of the Power Receiver may obtain wireless energy from the magnetic field and provide it to a power receiving circuit. The power receiving circuit may convert the energy and utilize it to charge or power a load. A Power Receiver may be included or integrated with a cordless appliance having a variable load (such as a blender, heating element, a fan, among other examples). In some implementations, the Power Receiver may be included or integrated with a cordless appliance having a fixed load).

During a power transfer phase, the Power Receiver may periodically communicate power control communication to the Power Transmitter via a communication channel. Power control communications may indicate presence or status, among other examples. Power control communications may include a power request, a null communication (to indicate presence without feedback), or power receiver feedback. The Power Transmitter and the Power Receiver may communicate via Near Field Communication (NFC), Bluetooth™, or other communications techniques.

This disclosure provides systems, methods and apparatuses for a Power Transmitter and a Power Receiver to communicate. Various implementations relate generally to messages for a communication protocol in a wireless power system. In some aspects, the communication protocol may be defined by a wireless power transfer standard. As the wireless power transfer standard has evolved, various message formats associated with a previously defined communication protocol may be inadequate to support new features and newly discovered fault conditions. In some aspects of this disclosure, traditional message formats may be modified to implement new functionality and features. Furthermore, some unexpected conditions of a Power Transmitter or Power Receiver may be addressed using communication signaling in a wireless power system.

In some aspects, a Power Transmitter may receive a control message (CTRL) indicating a requested power level (CTRL/rpl) that is below a minimum power level that the Power Transmitter can support for a power transfer phase. When this happens, in some implementations, the Power Transmitter may end the power transfer phase and transition to a connected phase. The Power Transmitter or the Power Receiver may initiate a power negotiation during the connected phase to establish a new power contract. In some implementations, the Power Transmitter may inform the Power Receiver of its minimum supported power level.

In some aspects, a Power Transmitter may experience an unexpected problem that causes the Power Transmitter to exceed current or power limits. For example, a sudden misalignment of the Power Receiver or a sudden Power Transmitter undervoltage condition may result in an inability of the Power Transmitter to deliver a negotiated power level to the Power Receiver. In such cases, the Power Transmitter may end the power transfer phase and initiate re-negotiation of a power contract with the Power Receiver.

During a connected phase, the Power Transmitter and the Power Receiver may negotiate a power contract. For example, the Power Transmitter and the Power Receiver may establish a Guaranteed Power level based on a power request from the Power Receiver and a confirmation from the Power Transmitter that the Power Transmitter can reserve sufficient power to meet the Guaranteed Power level. The Power Transmitter may reserve a Negotiated Power, which includes the Guaranteed Power that the Power Transmitter can commit to delivering to the Power Receiver as well as expected power transmission losses of the Power Transmitter to deliver the Guaranteed Power. In some cases, the Power Transmitter may determine that it does not have enough Available Power to accept the Requested Power level during the connected phase negotiation. When the Power Transmitter cannot accept the power contract, the Power Receiver may repeatedly send new Requested Power levels to negotiate a lower power contract. However, this process of negotiating the power contract may take multiple messages, cause delay, or result in a bad user experience. In some aspects of this disclosure, the Power Receiver may communicate a request for the Power Transmitter to indicate its Available Power or to request what Guaranteed Power the Power Transmitter can satisfy. Thus, the communication protocol between the Power Transmitter and the Power Receiver can improve power negotiation during the connected phase.

In some aspects, a Power Transmitter may fail to process communications from the Power Receiver during the power transfer phase. For example, a Power Receiver may communicate a message (such as a NEXT/con) to request a transition from the power transfer phase to the connected phase. Alternatively, or additionally, the Power Receiver may determine that the Power Transmitter is not transferring enough power to satisfy a requested power level (CTRL/rpl) and infer that the Power Transmitter is not processing the communications from the Power Receiver. If the Power Receiver determines that the Power Transmitter is unresponsive to the NEXT/con or CTRL/rpl messages, the Power Receiver may take steps to end power transfer and protect its load. For example, the Power Receiver may open a protective switch in its power reception circuit. In some implementations, the Power Receiver may open the protective switch at an instant when the AC mains voltage is below a threshold, such as during or near a communication slot (which also is a time when the wireless power signal has a voltage or current below a threshold level). Opening the protective switch during or near the communication slot may prevent damage that may otherwise happen to the Power Receiver or the Power Transmitter if the protective switch were to be opened at a high current. In some implementations, after opening the protective switch, the Power Receiver can harvest basic operating power using the communication carrier during the communication slots. In some implementations, the Power Receiver may cause a user interface (UI) of the Power Receiver to indicate the communication failure and then power down with the protective switch open.

In some aspects, a Power Receiver may communicate status to the Power Transmitter during connected phase or power transfer phase. For example, the Power Receiver may indicate status of its protective switch (open or close), indicate whether it has line power active (such that the Power Receiver is powered from an AC mains power source), indicate fault conditions, or indicate user activity, among other examples. In some implementations, the Power Receiver may indicate the status as an addition to traditional messages (such as a measurement (MEAS) or request (RQST) message. The status field being included as part of the MEAS or ROST message also may serve as a heartbeat or keepalive presence indicator that would otherwise be communicated by a separate message and communication overhead. In some implementations, the status may be useful in a Control Architecture Type 1 (which uses passive Near Field Communication (NFC®) to enable a Power Receiver to communicate its status to the Power Transmitter via a tag that the Power Transmitter reads during communication slots.

In some aspects, a communication physical layer channel between the Power Transmitter and the Power Transmitter may be adapted based on changes to alignment or other conditions. For example, during power transfer phase, a traditional Power Transmitter may keep an NFC carrier level at a constant carrier voltage level. However, the Power Receiver may change positions relative to the Power Transmitter such that the alignment between the Power Receiver and the Power Transmitter is changed. When the alignment changes, the effectiveness (or fidelity) of the communication may become unreliable unless the NFC physical layer channel is adapted. In some implementations, a Power Transmitter may determine a new coupling factor (indicating the alignment of the Power Receiver and the Power Transmitter) and adjust the NFC carrier level during the power transfer phase to accommodate a change in the coupling factor.

In some aspects, a Power Transmitter may determine that it cannot satisfy the Guaranteed Power during power transfer phase. The Power Transmitter may analyze the conditions to determine that the reason the Power Transmitter cannot satisfy the Guaranteed Power is due to a change in alignment (specifically, a misalignment) between the Power Receiver and the Power Transmitter. For example, if the Power Transmitter does not have an undervoltage condition and the Power Receiver had not reported a PRx-side fault condition, the Power Transmitter may check if a misalignment has occurred. The Power Transmitter may initialize a coupling factor (k-factor) measurement to determine the current alignment. If the k-factor is outside an acceptable range, the Power Transmitter may communicate a warning message to the Power Receiver to correct the alignment. Additionally, or alternatively, the Power Transmitter may end power transfer and transition to the connected phase.

In some aspects, a communication protocol message may be modified to enable a Power Transmitter to inform a Power Receiver regarding a fault condition of the Power Transmitter. For example, the fault condition may be an over-temperature, over-current, or over-voltage error condition, among other examples. In some aspects, the communication protocol described herein may support a Power Receiver to communicate a message to a Power Transmitter to cause the Power Transmitter to go to a standby state. In some aspects, a communication protocol message may be modified to permit communication of voltage and current information from a Power Receiver to a Power Transmitter, thereby enabling enhanced power control features.

Particular implementations of the subject matter described in this disclosure can be implemented to realize one or more of the following potential advantages. A Power Receiver and a Power Transmitter may support power negotiation, fault handling, and new features using the communication techniques described in this disclosure. The communication and fault handling techniques may prevent dangerous overvoltage or overcurrent conditions that might otherwise occur. Furthermore, user experience is improved by better fault power negotiation, fault handling, and error recovery procedures enabled by the disclosed communication techniques.

While the examples in this disclosure are based on wireless power used in kitchen systems, the techniques are applicable to other types of systems. For example, the techniques may be used with wireless power systems associated with home appliances, electronic devices, fans, space heaters, speaker systems, air compressors, garden equipment, or components of an electric vehicle, among other examples.

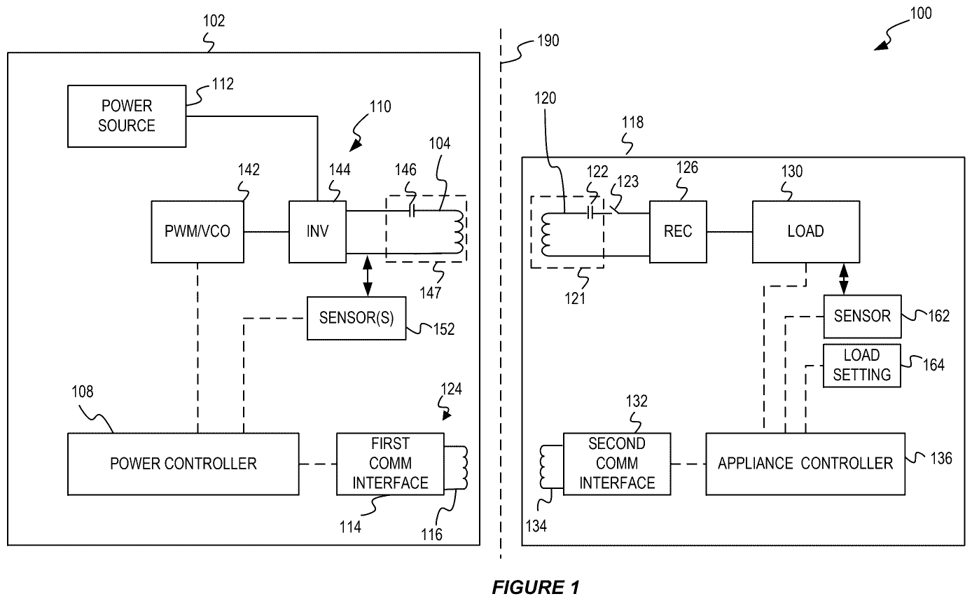

FIG. 1 shows a block diagram of an example wireless power system 100 that includes an example Power Transmitter 102 and an example Power Receiver 118. A Power Transmitter (sometimes referred to as “PTx”) is a functional unit that converts electric power to magnetic power. In this disclosure, Power Transmitter 102 includes the PTx as well as a communication system and other electrical components. A Power Receiver (sometimes also referred to as “PRx”) is a part of a wireless power transfer system that converts magnetic power to electric power or heat. In this disclosure, Power Receiver 118 includes the PRx as well as a communication system and other electrical components. The Power Transmitter 102 and the Power Receiver 118 may be separated by an interface space 190. In FIG. 1, dashed lines represent communications to distinguish from solid lines that represent electrical circuit lines. The Power Transmitter 102 includes a primary coil 104. The primary coil 104 may be a wire coil which transmits wireless power (which also may be referred to as wireless energy). The primary coil 104 may transmit wireless energy using inductive or magnetic resonant field. The primary coil 104 may be associated with a power transmitter circuit 110. The power transmitter circuit 110 may include components such as a pulse width modulator or voltage controlled oscillator 142, an inverter 144, and a series capacitor 146. The capacitor 146 and the primary coil 104 are sometimes also referred to as an “tank circuit 147”. The power transmitter circuit 110 may also include other components (not shown) for impedance matching. Power Transmitter 102 also may include one or more sensors 152, such as a voltage sensor and a current sensor (not shown).

Some or all of the power transmitter circuit 110 may be embodied as an integrated circuit (IC) that implements features of this disclosure for controlling and transmitting wireless power to one or more Power Receivers. The power controller 108 may be implemented as a microcontroller, dedicated processor, integrated circuit, application specific integrated circuit (ASIC) or any other suitable electronic device.

Power source 112 may provide power to the power transmitter circuit 110 in the Power Transmitter 102. Power source 112 may convert alternating current (AC) power to direct current (DC) power. For example, power source 112 may include a converter that receives an AC power from an external power supply and converts the AC power to a DC power used by the power transmitter circuit 110.

The power controller 108 is connected to a first communication interface 114. The first communication interface 114 is connected to a first communication coil 116. In some implementations, the first communication interface 114 and the first communication coil 116 may be collectively referred to as the first communication unit 124. In some implementations, the first communication unit 124 may support Near-Field Communication (NFC). NFC is a technology by which data transfer occurs on a carrier frequency of 13.56 Megahertz (MHz). The first communication unit 124 also may support any suitable communication protocol.

Power Receiver 118 may include a secondary coil 120, a series capacitor 122, a series switch 123, a rectifier 126, an appliance controller 136, a second communication interface 132, a sensor 162, a load 130, and a memory (not shown). The capacitor 122 and the secondary coil 120 are sometimes also referred to as an “tank circuit 121”. In some implementations, the Power Receiver 118 also may include a user interface (not shown) or other means for obtaining a load setting 164 indicating a desired operation of the load. In some implementations, the load setting 164 may be stored in a memory (not shown) of Power Receiver 118. In some implementations, load 130 may also include a drive (not shown) for controlling at least one parameter such as speed or torque of the load. In some implementations, the rectifier 126 may be omitted. In some implementations, a series switch (not shown) may be included in series with the secondary coil 120. Although shown as different components, some components may be packaged or implemented in the same hardware. For example, in some implementations, the appliance controller 136 and a power reception controller (not shown) may be implemented as a single controller. The appliance controller 136, or any combination thereof, may be implemented as a microcontroller, dedicated processor, integrated circuit, application specific integrated circuit (ASIC) or any other suitable electronic device.

An interface space 190 may demark a space between the Power Transmitter 102 and the Power Receiver 118. For example, the interface space may include a surface of the Power Transmitter 102 on which the Power Receiver 118 may be placed. A distance between the primary coil 104 and the secondary coil 120 may include a thickness of a surface in the interface space 190. During wireless power transfer, the primary coil 104 may induce a magnetic field (referred to as the primary magnetic field) through the interface space 190 and into an operative environment in which the secondary coil 120 is placed. Thus, the “operative environment” is defined by the primary magnetic field in the system, where the primary magnetic field of a primary coil 104 is detectably present and can detectably interact with the secondary coil 120.

The power controller 108 may detect the presence or proximity of a Power Receiver 118. This detection may happen during a periodic pinging process of the first communication interface 114 in Power Transmitter 102. During the pinging process, the first communication interface 114 also may supply power (via the first communication coil 116) to the second communication interface 132 (via the second communication coil 134) when the Power Receiver 118 is in proximity. The second communication interface 132 may “wake up” and power-up the appliance controller 136 and may send a reply signal back to the first communication interface 114. Prior to power transfer, a handshaking process may take place during which the power controller 108 may receive data configuration related to the power rating of the receiver, among other information.

Different cordless appliances have different load types, different load states, and different power requirements or may require power at a particular voltage and frequency. For example, a cordless blender may include a variable motor load that has multiple user-selectable load states to control motor speed. Depending on the load state, the cordless blender may require different levels of power to operate. In another example, a cordless kettle may include a resistive load that has different load states to control temperature. In yet another example, an air fryer may be a compound load device and may operate a heater, a fan, or both, at various periods of operation. Each type of load (such as the motor, the resistive load, the heater, the fan, or any combination thereof) may require different amounts of power to operate based on a current load state or load state. Furthermore, cordless appliances may exhibit different levels of voltage gains from a primary coil to a receiver coil at different primary coil excitation frequencies (such as a wireless power transfer frequency) depending on their load type or load state. For example, to achieve a desired load voltage, a cordless blender may operate best at a first operating frequency for a first load state, such as a low motor speed setting. However, as the load state changes, the cordless blender may not achieve the same load voltage when operated at the first operating frequency. For example, the first operating frequency may facilitate a first voltage gain when the cordless blender is set to a first load state (such as a low-speed setting), but the first operating frequency may provide a lower voltage gain when the cordless blender is set to a second setting (such as a higher-speed setting). The load setting 164 may indicate a current load state or a required power needed for the load to operate in the load state.

The power controller 108 may control characteristics of wireless power that that the Power Transmitter 102 provides to the Power Receiver 118. After detecting the Power Receiver 118, the power controller 108 may receive configuration data from a Power Receiver 118. For example, the power controller 108 may receive the configuration data during a hand shaking process with the Power Receiver 118. The power controller 108 may use the configuration data to determine at least one operating parameter (such as frequency, duty cycle, voltage, etc.) for wireless power generated by the power transmitter circuit 110. The operating parameter may be adjusted based on feedback information from the Power Receiver 118 during the transfer of wireless power in response to a change in the load state or power requirement of load 130. Thus, the power controller 108 may provide wireless power that enables relatively efficient operation of the Power Receiver 118. For example, the transmission controller may configure the wireless power to enable the Power Receiver to operate at peak efficiency for a particular load state, load voltage and operating K-factor.

A magnetic power source may refer to an appliance (such as a cooktop or hob) that includes multiple Power Transmitters to provide wireless power to respective Power Receivers. The Power Transmitters in such a magnetic power source typically share a limited power supply—such as a single wall outlet—and therefore typically cannot be operated simultaneously at full power. Exceeding the rated power of the magnetic power source can lead to tripping circuit breakers somewhere in the building, which is a highly undesirable situation. Such devices may use power negotiation to establish an agreed amount of power that a Power Transmitter will reserve for a particular Power Receiver.

Power negotiation may ensure that an appliance containing the Power Receiver can function as intended by reserving the amount of power to do so. Before a power transfer phase, the Power Receiver can communicate a Requested Power negotiation value to the Power Transmitter. The Requested Power negotiation value represents a maximum power level that the Power receiver may require to operate its load. The Requested Power negotiation value is communicated prior to a power transfer phase; thus, the Requested Power negotiation value may be referred to as a requested power level, a power negotiation value (PRx-nego), or a pre-power Requested Power to distinguish it from a traditional Power Request (P-request) message (sometimes also referred to as a Requested Power message) that may be communicated during the power transfer phase to control power. The Power Transmitter can determine whether to accept or reject the Requested Power negotiation value based on the Available Power of the Power Transmitter. Available Power refers to the highest amount of power that a Power Transmitter has available for wireless power transfer given instantaneous ambient conditions. Ambient conditions include, among others, the Power Transmitter's input power and voltage, its temperature, magnetic coupling of the Power Receiver. In a magnetic power source having multiple Power Transmitters, ambient conditions also may include the power usage of any other Power Transmitters or functions of the magnetic power source. For example, the multiple Power Transmitters can use the power negotiation techniques of this disclosure to reserve power from the Available Power provided by the magnetic power source.

The Power Transmitter can determine whether it can guarantee the requested power level (represented by the Requested Power negotiation value) based on the Available Power and estimated losses of the Power Transmitter. For example, the Power Transmitter may estimate the losses associated with its own components (such as its rectifier, inverter, coil, or filter components, among other examples) for servicing the requested power level. If the Available Power is more than the Requested Power negotiation value and the estimated losses, the Power Transmitter may accept the Requested Power negotiation value; otherwise, the Power Transmitter may reject the Requested Power negotiation value or may communicate an alternative power negotiation value for a power level that is lower than the requested power level. When the Power Transmitter accepts the Requested Power negotiation value, the Power Transmitter may set the Requested Power negotiation value as a Guaranteed Power to represent a power level that the Power Transmitter will guarantee to be available for transmission to the Power Receiver. The Power Transmitter may reserve a Negotiated Power (P-nego) out of the Available Power to ensure that the Power Transmitter has enough power to satisfy the Guaranteed Power. The Negotiated Power may be the sum of the Guaranteed Power and the estimated losses.

In some implementations, a Power Receiver may communicate a Requested Power negotiation value that takes into account a power rating of a load associated with the Power Receiver. The Requested Power negotiation value also may take into account power reception losses (PRx-loss) associated with components of the Power Receiver. However, the Requested Power negotiation value may exclude power transmission losses (PTx-loss) associated with components of the Power Transmitter since those losses will be estimated by the Power Transmitter.

In some implementations, the Power Transmitter may determine an operating coupling factor (K-factor) between the Power Transmitter and the Power Receiver. An operating K-factor refers to a K-factor based on an actual alignment between the Power Receiver and the Power Transmitter. The Power Transmitter may adjust the PTx-loss based on the K-factor.

The Power Transmitter 102 and the Power Receiver 118 may implement a control architecture for managing the transfer of wireless power. The control architecture may define how power requirements are communicated and how an operating point of the power transmitter is controlled. In some implementations, the control architecture may be based on static power control (referred to as “control type 1 architecture” or “type 1”). In some implementations, the control architecture may be based on dynamic power control (referred to as “control type 0 architecture” or “type 0”). An appliance that implements the control type 1 architecture may have a fixed load, might not include measurement circuits, typically may not employ auxiliary data transfer, and may require only minimal functionality so as to contain manufacturing costs. The control type 1 architecture may rely on a control loop of the power transmitter 102 without feedback from the Power Receiver 118. An appliance that implements the control type 0 architecture may have a static or dynamic load and may implement a controller to generate a power request message during power transfer as well as measurement circuits for proper control of its load. This disclosure includes examples of both type 0 and type 1 control architectures as they relate to transitions between various operating phases.

In some implementations, the wireless communication interface 114 may communicate with a power receiver by transmitting a wireless communication signal and detecting changes in the wireless communication signal that represent communication of information. The wireless communication interface 114 may support NFC Type 2 Tag specifications or NFC Type 4A Tag specifications, as specified by an NFC specification. During a power transfer phase, the communications carrier and the power signal may both be active. Due to the frequency range used for the power signal, the inter-modulation products of the two signals result in interferences disturbing the reliable NFC communication. In order to avoid this unwanted effect, the power signal may be periodically switched-off for short time intervals. The time intervals may be referred to as communication time slots. Typically, the communication time slots may occur in relation to a zero-cross event associated with an AC cycle of an AC mains power or wall plug.

The wireless communication unit 132 may support NFC Type 2 Tag specifications or NFC Type 4A Tag specifications, as specified by an NFC specification. In some implementations, the wireless communication unit is configured to communicate with the power transmitter by storing information in a passive tag (such as an NFC Type 2 Tag) that can be read by a wireless communication interface of a power transmitter. Alternatively, wireless communication unit may be configured to communicate with the power transmitter by transmitting information (such as using an NFC Type 4A Tag) in a wireless communication signal to the wireless communication interface of the power transmitter.

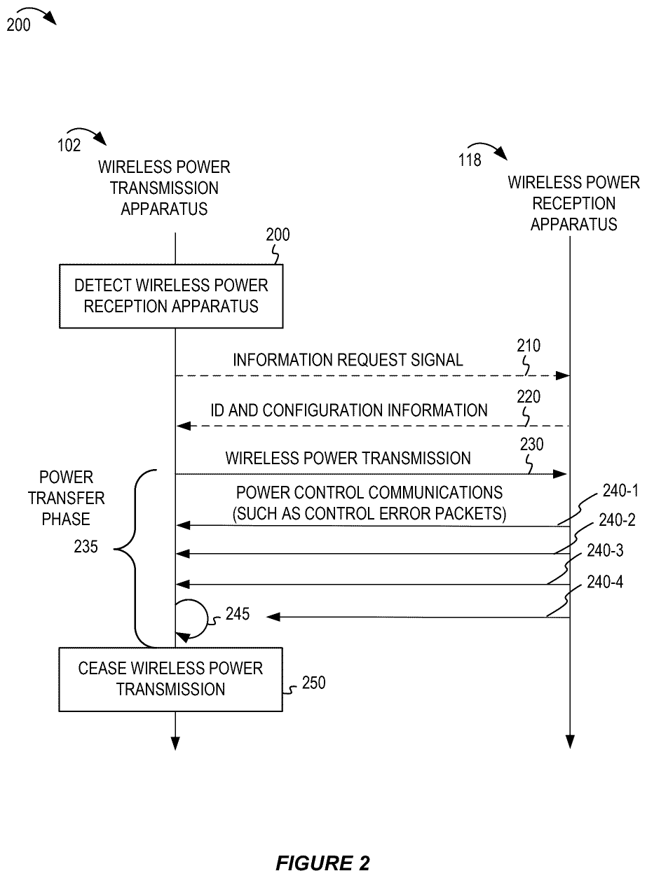

FIG. 2 shows a message flow diagram of an example wireless power transmission process. Referring to FIG. 2, a Power Transmitter 102 detects that a Power Receiver 118 is located in a charging area in a standby mode (S200). There may be various methods for detecting the Power Receiver 118 by the Power Transmitter 102, and not limited to a specific method in the present disclosure. As an example, the Power Transmitter 102 may detect that the Power Receiver 118 is located in a charging area by periodically emitting analog ping of a specific frequency, and based on detection current for this, resonance shift or capacitance change. As another example, the Power Transmitter 102 may periodically transmit a detection signal and the Power Receiver 118 may transmit a response signal (for example, a control error packet or a signal strength packet). The Power Transmitter 102 may detect that the Power Receiver 118 is located in the charging area based on receiving the response signal within a predetermined time period following the detection signal. As yet another example, the Power Receiver 118 may transmit a searching signal or an advertisement signal to the Power Transmitter 102. The searching signal or the advertisement signal may traditionally be transmitted using short range radio frequency communication (such as NFC or Bluetooth™). The Power Transmitter 102 may detect the Power Receiver 118 based on reception of the searching signal or the advertisement signal.

In some implementations, as a preparation step for a wireless power transmission, the Power Transmitter 102 may optionally transmit an information request signal to the Power Receiver (S210). The information request signal may be a signal for requesting an ID and requesting power information of the Power Receiver 118. As an example, the information request signal may be transmitted in the form of data packet message. As another example, the information request signal may be transmitted in a form of digital ping according to a predefined standard between the Power Transmitter 102 and the Power Receiver 118. In response to the information request signal, the Power Receiver 118 may optionally transmit the ID and configuration information to the Power Transmitter 102 (S220). For example, the configuration information may include a requested amount of power or a maximum amount of power that is provided for the Power Receiver 118. In some implementations, the configuration information may include a rated power value associated with the load or an operation of the load. In some implementations, the configuration information also may include a time parameter. For example, the time parameter may indicate an expected time for the Power Receiver to complete the operation based on the rated power value. In some implementations, the information request signal and the ID and configuration information may be communicated using out-of-band communication (separate from the wireless power signal) such as NFC or Bluetooth.

Based on the ID and configuration information, the Power Transmitter 102 configures parameters (referred to as an operating point) for power transmission and performs a wireless power transmission to the Power Receiver 118 (S230). For example, the Power Transmitter may create a power transmission contract based on the ID and the configuration information and may control the wireless power transmission according to the power transmission contract. The process, performed by the Power Transmitter 102, from the start to the end of the wireless power transmission to the Power Receiver may be called a (wireless) power transfer phase 235. In some implementations, the Power Receiver 118 may provide the received wireless power to an external load such as a heating element, motor, or battery, among other examples. In some implementations, an operation of the Power Receiver 118 may be based on the external load and a user-configurable setting. For example, the operation may include boiling water, toasting bread, or cooking food. In other examples, the operation may be based on charging a battery or other energy storage device to a desired level.

The Power Transmitter 102 may monitor the parameters for power transmission and may abort the wireless power transmission when any one of the parameters exceeds a stated limit. Alternatively, the wireless power transmission process of S230 may be ended by a request of the Power Receiver 118. For example, the Power Receiver 118 may transmit a signal for requesting termination of the wireless power transmission to the Power Transmitter 102, when the operation of the Power Receiver 118 is complete.

During the power transfer phase 235, the Power Receiver 118 periodically transmits power control communications to the Power Transmitter 102 (shown at S240-1, S240-2, S240-3, and S240-4). Examples of a power control communication may include a control error packet (CEP), a power request message, or a status message, among other examples. This is performed for controlling an amount of power which is transmitted from the Power Transmitter 102 to the Power Receiver 118, that is, to perform a power control.

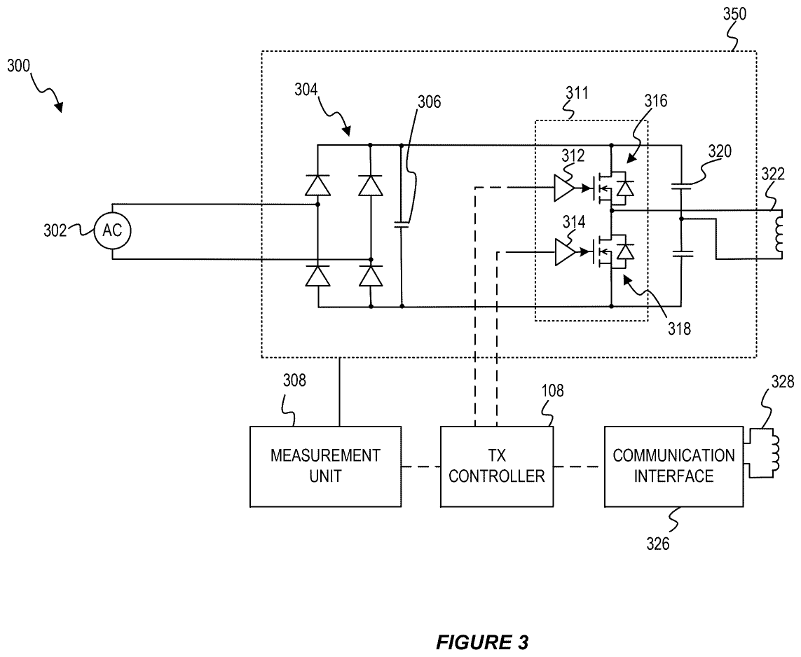

FIG. 3 shows a block diagram conceptually illustrating an example Power Transmitter 300. The Power Transmitter 300 may be an example of the Power Transmitter 102 described with reference to FIGS. 1 and 2, respectively. The Power Transmitter 300 may include a power source 302, which is shown as an AC power source. However, the power source 302 may be a DC power source or any other suitable source power. The power source 302 may be connected to a rectifier 304 (which also may be referred to bridge rectifier, or other related terms). The rectifier 304 which may be connected to a capacitor 306. The rectifier 304 may provide DC power to a first switch 316 and a second switch 318. The first switch 316 and second switch 318 together form an inverter 311 that generates an AC voltage from the DC power. The first switch 316 and the second switch 318 may be metal-oxide-semiconductor field-effect transistors (MOSFETs) or Insulated Gate bipolar Transistors (IGBTs), among other examples. A first pulse width modulator (PWM) driver 312 may be connected to the first switch 316, and a second PWM driver 314 may be connected to the second switch 318. The TX controller 108 may be connected to the first PWM driver 312 and the second PWM driver 314. The TX controller 108 may control the PWM drivers 312 and 314 to cause wireless power transmission according to a desired operating frequency, operating duty, or operating frequency, among other examples. The Power Transmitter 300 may include other components (such as capacitors 320) in the path between the power source 302 and a primary coil 322. The rectifier 304, capacitor 306, inverter switches 316 and 318, and capacitors 320 may be collectively referred to as the power transmitter (PTx) circuit 350. The TX controller 108 controls one or more components of the PTx circuit 350 to manage the transmission of wireless power.

The TX controller 108 may exchange communications with a Power Receiver via a communication unit. The communication unit may include a communication interface 326, a communication controller (not shown) or other component connected to a communication coil 328. In some implementations, the communication interface 326 and the communication coil 328 are configured to communicate using an NFC communication protocol. In some implementations, the communication interface 326 and the TX controller 108 may be collocated in a common processor or chip.

The TX controller 108 may detect the Power Receiver in proximity to the primary coil 322 and conduct a handshaking process during which the TX controller 108 receives information from the Power Receiver. The TX controller 108 may receive the information via the communication interface 326. In some implementations, the information may include one or more reference control parameters such as operating frequencies of the Power Receiver at different reference coupling factors (K-factors), load voltages and load powers of the Power Receiver. In some implementations, the information may indicate a load type and a load state for a variable load associated with the Power Receiver. Load state represents the combined state of load voltage and corresponding load power of the appliance. The TX controller 108 may utilize this information to provide wireless power having characteristics that enable the Power Receiver to operate. For example, the TX controller 108 may determine an operating parameter and provide wireless power by controlling the first and second PWM drivers (312 and 314, respectively) based on the operating parameter. The PWM drivers (312 and 314, respectively) may operate the first switch 316 and the second switch 318. The first switch 316 and second switch 318 may energize the primary coil 322 in a manner that transmits wireless power according to the operating parameter to a secondary coil of the Power Receiver.

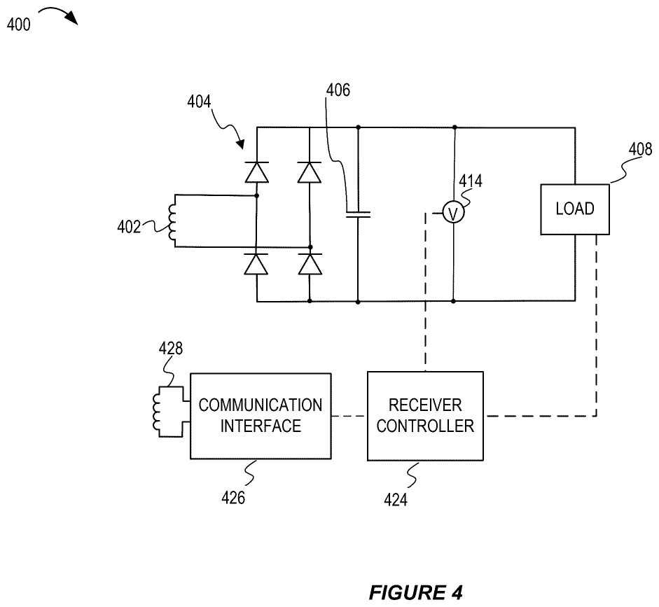

FIG. 4 shows a block diagram conceptually illustrating an example Power Receiver 400. The Power Receiver 400 may be an example of the Power Receiver 118 described with reference to FIGS. 1, 2 and 3. The Power Receiver 400 includes a secondary coil 402. The secondary coil 402 may be connected to a rectifier 404 and a capacitor 406. In some implementations, the secondary coil 402 is connected to the rectifier 404 via a series capacitor (not shown), a series switch (not shown), or other electrical components. The rectifier 404 may be electrically coupled to the load 408 or an energy storage device (not shown, such as a battery) through a series switch (not shown). In some implementations, the rectifier 404, the capacitor 406, or both, may be absent in the Power Receiver, depending on the kind of load 408 (such as heating elements). The Power Receiver 400 also may include a communication unit 432. The Power Receiver 400 also may include a communication interface 426, which may include a second communication coil 428. The communication interface 426 may be connected to a Receiver controller 424.

The receiver controller 424 may receive various information and determine a control error value, a power request value or other feedback to communicate to a Power Transmitter via the communication unit 432. In FIG. 4, dotted lines represent control or information lines to distinguish from solid lines that represent electrical circuit lines. The control or information lines may include electrical connections to or from a receiver controller 424 and other components of the Power Receiver 400. In some implementations, the receiver controller 424 may receive information indicating load settings, power requirements or power estimates from a load controller (not shown) connected to the load 408. The receiver controller 424 also may receive voltage information from a voltage sensor 414 that is connected to the rectifier 404. The voltage information may indicate a voltage available to the load 408. However, the voltage sensor 414 may fail or may not be present in some implementations of the example Power Receiver 400.

The RX controller 424 also may communicate with a Power Transmitter via the communication interface 426. In some implementations, the RX controller 424 may obtain configuration data from a memory (not shown). The configuration data may be transmitted by the communication interface 426 to the Power Transmitter. The RX controller 424 also may obtain information indicating load states and/or power estimates from a load controller (not shown) or user interface (not shown). At various times before, during, or after the transfer of wireless power, the communication interface 426 may transmit, to the Power Transmitter, the aforementioned configuration data, voltage measurement information, coupling information, power request information, load voltage information, the load state, among other examples. The load setting may be a user-selectable setting, such as a temperature setting, cooking time, or motor speed setting, among other examples. In some implementations, the configuration data may include a rated power value and a time parameter associated with an operation of the load 408. For example, the time parameter may indicate an expected time to boil water, toast bread, or cook food based on the load setting. In some instances, the RX controller 424 may transmit some or all of the configuration data to the transmission controller during a handshaking process, as described herein. In some instances, the RX controller 424 may transmit feedback information to a Power Transmitter. The feedback information may include one or more of a load state, a reference voltage, a power estimate or request for the load, the coupling factor information, the load voltage information, a fault state (when detected by the example Power Receiver 400), or any combination thereof.

A TX controller (not shown) of the Power Transmitter may modify the wireless power being transmitted to the Power Receiver 400 based on the feedback information. The communication interface 426 may be configured to communicate messages to the Power Transmitter during predetermined communication slots. For example, the communication slots may be determined based on a synchronization unit (not shown), clock, or other device. For example, communication slots may occur at times when there is no switching in the Power Transmitter and may be determined when the coil sensed voltage (at the secondary coil 402) is zero.

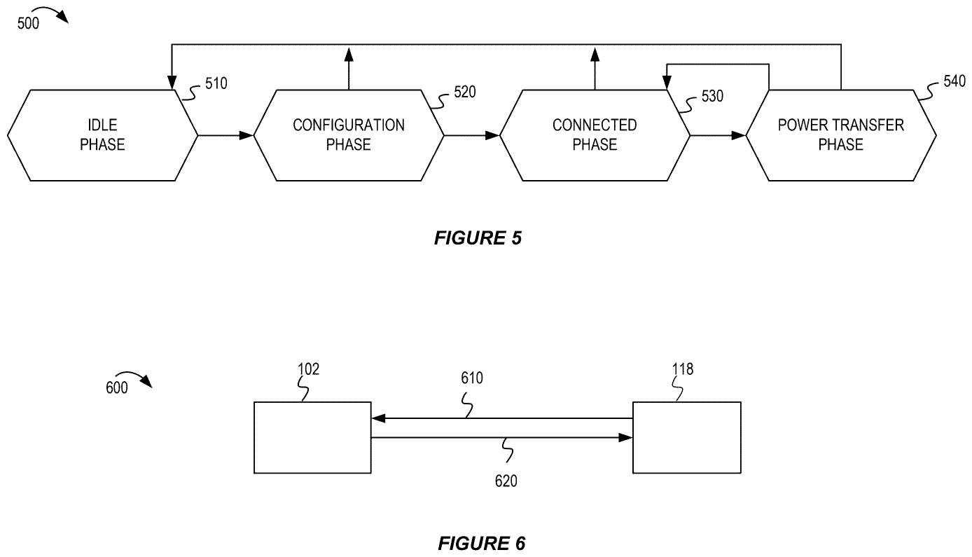

FIG. 5 shows an example system state diagram 500 with example power negotiation operations. The system state diagram 500 consists of four main phases. The Power Transmitter enters the idle phase 510 when the user connects it to the mains. In the idle phase 510, the Power Transmitter looks for the presence of a valid receiver and when detected, establishes communication. In the idle phase 510, the Power Transmitter is in standby until it detects an event that initiates object classification. If the object is a Power Receiver with a communication unit, the Power Transmitter initiates communication then moves to the configuration phase 520. After the activation of the Power Receiver, the Power Transmitter moves into the configuration phase 520 and receives the static configuration data. The system state diagram 500 also shows the connected phase 530 which follows the configuration phase 520 and before a power transfer phase 540. Power transfer from the Power Transmitter to the Power Receiver occurs during the power transfer phase 540.

In the configuration phase 520 or the connected phase 530, the Power Transmitter and Power Receiver exchange information to agree and adjust parameters related to wireless power transfer or wireless charging. Power negotiation may occur during any of the phases before the power transfer phase 540. For example, the power negotiation may occur during the connected phase 530. Power negotiation is used by the Power Transmitter and Power Receiver to negotiate the parameters that govern the power transfer phase 540.

A brief description of power negotiation follows. The Power Receiver may communicate a Requested Power negotiation value to the Power Transmitter. The Requested Power negotiation value may be based on the power rating of the load. In some implementations, the Requested Power negotiation value is based on a combination of the power rating of the load and power reception losses (PRx-loss). The Requested Power negotiation value may omit or disregard the power transmission losses (PTx-loss) since those will be estimated and accounted for by the Power Transmitter during power negotiation. The Power Receiver and the Power Transmitter may negotiate a Guaranteed Power based on the Requested Power negotiation value, the estimated PTx-loss, and the Available Power. For example, the Power Transmitter may accept or reject the Requested Power negotiation value as the Guaranteed Power. For example, the Power Transmitter may accept the Requested Power negotiation value as the Guaranteed Power if the Available Power is more than a sum of the Requested Power negotiation value and the estimated PTx-loss. Alternatively, there may be cases when the Power Transmitter cannot accept the Requested Power negotiation value as the Guaranteed Power. For example, the Power Transmitter may determine that the Available Power is less than the sum of the Requested Power negotiation value and the estimated PTx-loss. The Power Transmitter may communicate a message to the Power Receiver indicating that the Power Transmitter rejects the Requested Power negotiation value. In some implementations, the Power Receiver may communicate a subsequent Requested Power negotiation value and wait for an acceptance or rejection of the Requested Power negotiation value as the Guaranteed Power. In some implementations, the Power Transmitter may calculate an alternative power negotiation value that the Power Transmitter can satisfy based on the Available Power minus the estimated PTx-loss. The Power Transmitter may communicate the alternative power negotiation value (sometimes referred to as a suggested power negotiation value) to the Power Receiver. The Power Receiver may respond with an acknowledgement if the Power Receiver accepts the alternative power negotiation value as the Guaranteed value.

Once the Guaranteed Power has been negotiated, the Power Transmitter may reserve a Negotiated Power (based on a sum of the Guaranteed Power and the estimated PTx-loss) out of the Available Power, thereby reducing the Available Power for other Power Transmitters that share the Available Power. Each Power Transmitter may perform similar power negotiation (and reservations of Negotiated Power) with their respective Power Receivers using the Available Power remaining after reservations from other Power Transmitters. Because the Negotiated Power accounts for the estimated PTx-loss, the total power usage by multiple Power Transmitters will not exceed the Maximum Power of the power source.

From the connected phase 530, the Power Receiver can request the Power Transmitter to move to the power transfer phase 540 or back to the idle phase 510. In the power transfer phase 540, the Power Transmitter may perform Foreign Object Detection (FOD) operations, then applies the power signal to transmit wireless power to the Power Receiver, repeating this cycle for the duration of the power transfer phase 540. Communication or FOD is performed during each slot in the power signal. Some examples of communication in the power transfer phase 540 may be relevant to power negotiation. For example, during the power transfer phase 546, the Power Receiver may communicate a Power Request (P-request) message (sometimes referred to as “Requested Power” or CTRL/rpl) to cause the Power Transmitter to adjust the power level of the wireless power transfer to the Power Receiver. The Requested Power during power transfer phase may not exceed the Guaranteed Power negotiated between the Power Transmitter and the Power Receiver.

FIG. 6 shows a block diagram 600 conceptually illustrating a communication protocol. A Power Transmitter 102 may communicate with a Power Receiver 118. The communication protocol may include a message 610 from the Power Transmitter 102 to the Power Receiver 118 or a message 620 from the Power Receiver 118 to the Power Transmitter 102, or both. This disclosure includes several enhancements to the communication protocol to support various features of a wireless power system. In some implementations, the communication protocol is implemented using NFC communication units at the Power Transmitter 102 and the Power Receiver 118.

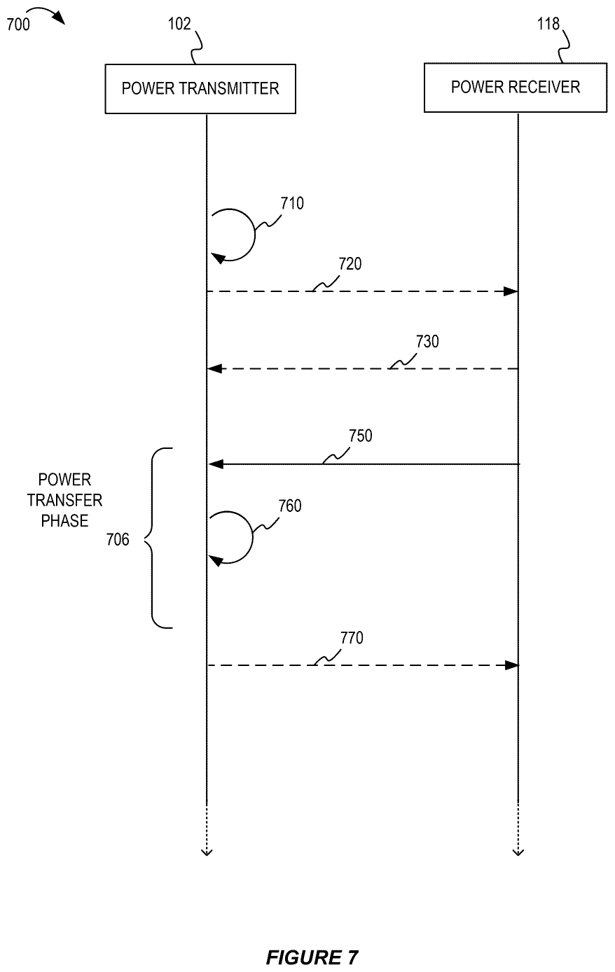

Listed below (as example aspects) are some example enhancements that may be implemented in the communication protocol. Further examples are provided with reference to FIGS. 7-13.

### Example Aspect 1

A Power Transmitter may decide independently from any Power Receiver request to go into a standby phase (out of the power transfer phase). For example, the Power Transmitter may use a NEXT/stb command or may switch off the power signal and communications carrier. The Power Transmitter may send a message requesting the Power Receiver to enter the standby state. The Power Receiver would acknowledge whether this can be done or not depending on the state that the Power Receiver is currently in (such as if there is no user interaction, no intention to operate). Thus, the Power Transmitter may communicate to the Power Receiver to request a standby mode transition.

In some aspects, a Power Receiver may send a communication message to the Power Transmitter to ask the Power Transmitter to go to the standby state. The Power Transmitter can decide whether it can transition to the standby state based on the regulation requirement and other activities through a user interface at the Power Transmitter side.

### Example Aspect 2

A Power Transmitter may a Power Receiver may communicate measurement information to aid in power control. A measurement (MEAS) message is used to exchange measured values of an indicated parameter. A MEAS message may enable communication of power level, surface temperature, version information, buffer information, status, or identification. In some aspects, the MEAS message may be modified to enable communication of PRx voltage, PRx current, or both, via a MEAS message from the Power Receiver to the Power Transmitter. Appendix A shows example message formats that may be incorporated into the MEAS message.

### Example Aspect 3

The communication protocol may include a message that enables a Power Transmitter to inform a Power Receiver regarding a fault condition detected in the Power Transmitter. For example, the message may be used to indicate over-temperature, over-current, or over-voltage, presence of a foreign object among other example error conditions. By knowing the error condition of the Power Transmitter, the Power Receiver may adapt or cease wireless power transfer to mitigate the error condition.

FIG. 7 shows an example message flow diagram 700 conceptually illustrating an example communication enhancement. Shown at block 710, a Power Transmitter 102 may set a PTx minimum supported power level of the Power Transmitter 102. The PTx minimum supported power level may be based on the measurement and processing capability of the Power Transmitter. Currently, a traditional communication protocol does not define a PTx minimum supported power level (a nonzero number). For example, a PTx minimum supported power level as low as 1 Watt (1W) may be hard for the Power Transmitter 102 to regulate. Alternatively, or additionally, the PTx minimum supported power level may be based on device capability, sensor tolerances or processing sensitivity. A Power Transmitter 102 may not be able to regulate at an operating point at the requested power level below a PTx minimum supported power level.

During a power transfer phase 706, a Power Receiver 118 may communicate control messages (such as CTRL/rpl messages) to the Power Transmitter 102 to adjust the power level of the power channel on a regular or periodic basis. In FIG. 7, a control message 750 may be an example CTRL/rpl message. The Power Receiver 118 may attempt to set the power level to a value that is too low for the Power Transmitter to effectively regulate. As a result, the Power Transmitter 102 may unnecessarily transmit power into the Power Receiver 118 while attempting to reach the requested power level below the PTx minimum supported power level, potentially which results in an overvoltage condition at the Power Receiver. Shown at block 760, the Power Transmitter 102 may determine that the power control message 750 indicates a requested power level that is below the PTx minimum supported power level.

If the power request (in power control message 750) falls below that PTx minimum supported power level, the Power Transmitter 102 may move out of the power transfer phase 706 and into a pre-power phase (such as a connected phase or configuration phase). The Power Transmitter 102 may end power transfer and may communicate a message (shown at message 770) to cause the Power Receiver 118 to transition to the connected phase.

In some implementations, the Power Receiver 118 may communicate a configuration value 730 during a pre-power transfer phase (such as a configuration phase or a connected phase). The configuration value 730 may indicate a PRx minimum power limit (PRx-min-power) that the Power Receiver 118 will request during the power transfer phase 706. The Power Transmitter 102 may verify that the PRx-min-power is higher than the PTx minimum supported power level before the power transfer phase 706.

In some implementations, the Power Transmitter 102 may communicate the PTx minimum supported power level to the Power Receiver in a message 720 so that the Power Receiver 118 can manage power requests or phase transitions in accordance with the PTx minimum supported power level.

FIG. 7 also may be used to illustrate another example aspect. As described herein, a communication protocol may include power control messages (such as CTRL/rpl messages) in which a Power Receiver 118 requests a power level. The Power Transmitter is expected to control the power transmitted from the primary coil to within a percentage (such as 5-10%) of the requested power level within a time interval (such as 10-50 milliseconds) after receiving the CTRL/rpl message. During the power transfer phase 706, the Power Transmitter 102 may exceed current or power limits may occur for different reasons such as sudden Power Receiver misalignment or Power Transmitter source input power (such as an AC mains) undervoltage. Traditional implementations of a Power Transmitter may allow the Power Transmitter 102 to disregard the CTRL/rpl message in such cases. For example, a traditional Power Transmitter may ignore the requested power level (CTRL/rpl) coming from the Power Receiver 118 if the requested power level would cause the PTx power or current to exceed its limits. However, the Power Receiver 118 may be unaware of the limits or may be unaware when the CTRL/rpl message is disregarded due to an over limit condition. In some implementations, instead of disregarding the power level request, the Power Transmitter 102 implementing aspects of this disclosure may initiate a renegotiation with the Power Receiver to adjust the power level request limits from the Power Receiver side.

In some aspects, at block 760, the Power Transmitter 102 may determine that the power control message 770 indicates a requested power level that would cause the Power Transmitter 102 to exceed a current or power limit of the Power Transmitter 102 or that the Power Transmitter 102 cannot satisfy a Guaranteed Power. The Power Transmitter 102 may transition from the power transfer phase 706 to a connected phase. In some implementations, The Power Transmitter may communicate a message 770 to the Power Receiver 118 to transition to connected phase. The message 770 may also indicate the requested power level (in power control message 750) would exceed its limits. For example, the message 770 may include an explicit indication that the limits would be exceeded or may be an implicit indication based on an error indicator or phase change.

In some implementations, after transitioning out of the power transfer phase 706, the Power Transmitter 102 may communicate a suggested power negotiation value (to establish a new Guaranteed Power level) for a subsequent power transfer phase (not shown). The suggested power negotiation value may indicate a Guaranteed Power that the Power Transmitter 102 can support based on current conditions of the Power Transmitter 102.

FIG. 8 shows a message flow diagram 800 conceptually illustrating an example power negotiation. A Power Transmitter 102 and a Power Receiver 118 may establish communication during a configuration phase 802 and exchange identification and configuration messages 810. In the connected phase 804, the Power Transmitter 102 and the Power Receiver 118 may perform a power negotiation. In some implementations, the Power Transmitter 102 may determine and communicate a negotiation message 820 that indicates an Available Power or a Maximum Power. At 830, the Power Receiver 118 may determine a Requested Power negotiation value. The Requested Power negotiation value may be based on a power rating of the Power Receiver 118 and power reception losses (PRx-loss). The PRx-loss may be estimated, calculated, measured or programmatically configured. The Power Receiver 118 may communicate a negotiation message 840 that includes the Requested Power negotiation value. At 842, the Power Transmitter 102 may estimate power transmission losses (PTx-loss). The PTx-loss may be estimated, calculated, measured or programmatically configured. In some implementations, the estimated PTx-loss may be the losses that are expected to reduce the actual transmitted power to the Power Receiver 118 based on current conditions and the requested power level associated with the Requested Power negotiation value.

If the Power Transmitter 102 can reserve the amount of power that corresponds to the Requested Power negotiation value plus the PTx-loss, the Power Transmitter 102 may communicate a response message 844 indicating whether the Power Transmitter 102 accepts the Requested Power negotiation value as the Guaranteed Power. Otherwise, if the Power Transmitter 102 cannot reserve the amount of power that corresponds to the Requested Power negotiation value plus the PTx-loss, the Power Transmitter 102 may communicate a response message 844 indicating that the Power Transmitter 102 rejects the Requested Power negotiation value.

In a traditional power negotiation, the Power Receiver 118 may continue using Requested Power negotiation values (not shown), lowering the Requested Power negotiation value each time in successive messages and receiving a response from the Power Transmitter. This series of messages back and forth may continue until the Power Transmitter 102 accepts the Requested Power negotiation value. However, such a process may be time consuming and frustrating for a user. In accordance with some aspects of this disclosure, instead of sending another power request, the Power Receiver 118 may communicate a negotiation value request message 850 (such as a NEGO/rqp message) requesting the Power Transmitter 102 to provide a suggested power negotiation value (such as a suggested Guaranteed Power in a NEGO/avp other power negotiation message). The Power Transmitter 102 may respond with the suggested power negotiation value in message 860. Thereafter, if the suggested power negotiation value is acceptable to the Power Receiver 118, the Power Receiver 118 may send the suggested power negotiation value as a Requested Power negotiation value. This avoids renegotiation multiple times and if the guaranteed power is sufficient for operating the PRx can decide to go to power transfer phase, else can send a NEXT/stb or NEXT/con command.

In some implementations, the Power Transmitter 102 may communicate a negotiation message in addition to, or lieu of, the response message 870 to indicate an alternative power negotiation value. In some implementations, the alternative power negotiation value by the transmitter may correspond to the Available Power minus the estimated PTx-loss.

Continuing with FIG. 8, in the illustrated example, the Power Transmitter 102 has accepted the Requested Power negotiation value. At 872, the Power Transmitter 102 sets the Guaranteed Power based on the Requested Power negotiation value. The Power Transmitter 102 also calculated a Negotiated Power as a sum of the Guaranteed Power and the estimated PTx-loss. Then the Power Transmitter 102 reserves the Negotiated Power out of the Available Power. The Available Power for the power source may be reduced by the Negotiated Power so that it is reserved for the Power Transmitter 102 and not available for other Power Transmitters that share the power source. At 874, the Power Receiver 118 may configure the Guaranteed Power as a maximum limit for subsequent Power Request messages communicated during the power transfer phase.

During the power transfer phase 806, the Power Receiver 118 may transmit a Power Request (P-request) message 880 or other feedback message to request an adjustment to the wireless power transmission. For example, the Power Request message 880 may include a P-request as described with reference to FIG. 6. The P-request may be limited such that it does not exceed the Guaranteed Power that was negotiated with the Power Transmitter 102 based on the Requested Power negotiation value.

At 882, the Power Transmitter 102 may calculate the PTx-loss based on measurements at the inverter of the Power Transmitter 102. At 884, the Power Transmitter 102 may determine a new operating parameter to satisfy the P-request taking into account the calculated PTx-loss.

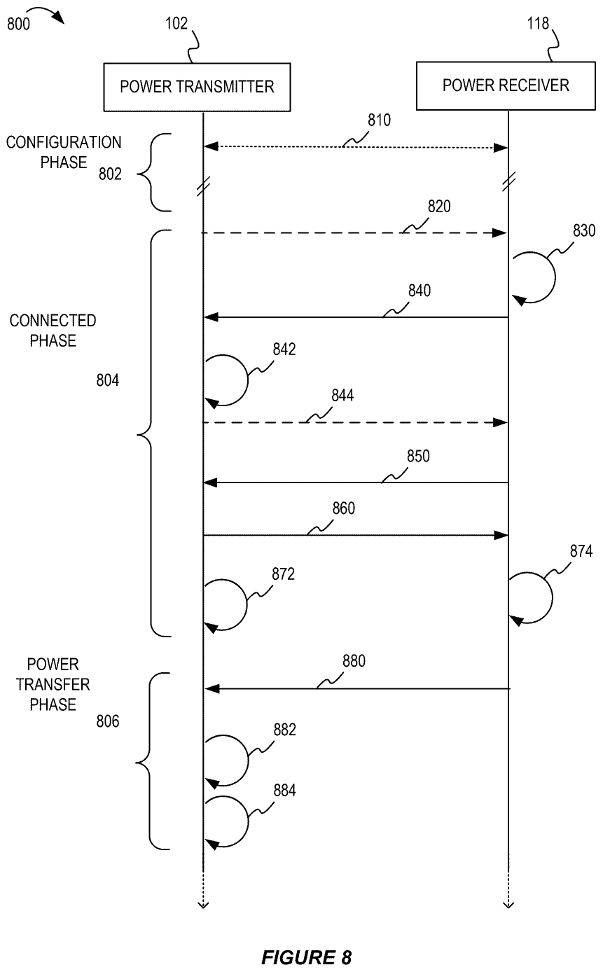

FIG. 9 shows an example communication technique 900 for a Power Receiver to indicate status. Traditional communication messages from a Power Transmitter to a Power Receiver provide a field for the Power Transmitter to indicate PTx status. However, there is currently no technique for a Power Receiver to indicate PRx status. Furthermore, as new features and fault handling techniques are implemented, there is a need for the Power Transmitter to be aware of PRx status. In some aspects, a communication message from the Power Receiver to a Power Transmitter may include a status field (such as PRx status). The status field may be a one or more bits. In some implementations, the status field is one byte with various bits allocated to a status value or indicator.

Example PRx status indicators 910 may include an indication of whether wired power is available. For example, the indication may be useful for a hybrid PRx that supports both wired and wireless power sources. A status bit (such as “wired ON” indicator) may indicate if the PRx (appliance) is powered by a wired power source. A first value (such as “1”) on this status bit may indicate that the appliance is powered by a wired power source (such as an AC mains) and a second value (such as “0”) may indicate that the PRx is requiring wireless power from the PTx. Other example PRx status indicators 910 may include an indication of whether a protective switch is open or closed or an indication of PRx fault status. The example PRx status indicators are provided for pedagogical purposes and not intended as an exhaustive or exclusive list. Furthermore, some implementations may omit or include various ones of the example PRx status indicators described herein.

In some implementations, the status field may be included in a MEAS or ROST message. Furthermore, because the PRx can communicate the status in the MEAS or ROST message, traditional techniques for determining whether the PRx is active (such as an ECHO message) may be eliminated. The status communicated by the Power Receiver may serve as a heartbeat or keepalive presence indicator that would otherwise be communicated by a separate message and communication overhead.

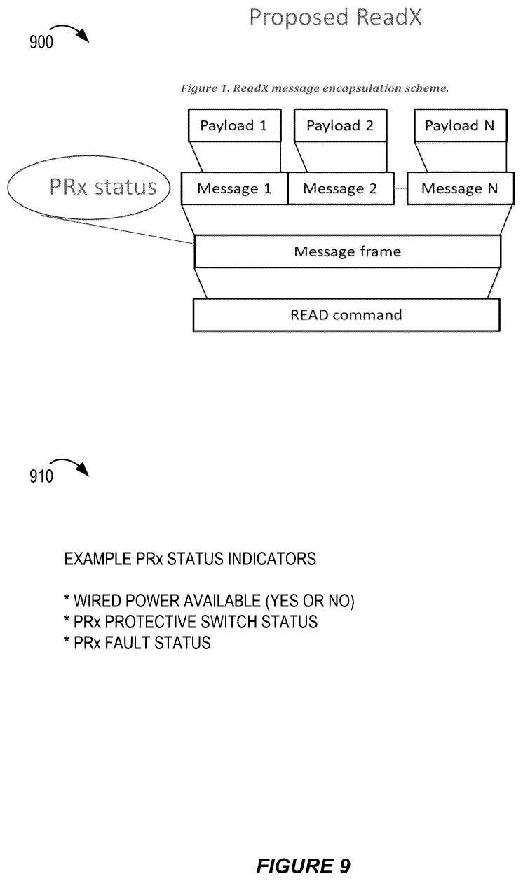

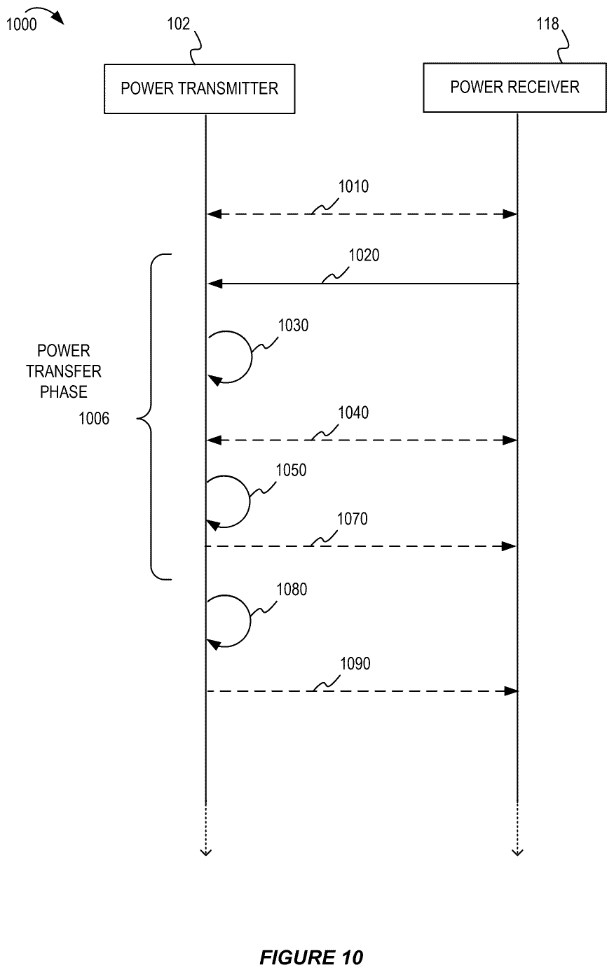

FIG. 10 shows a message flow diagram 1000 conceptually illustrating an example communication technique for addressing a misalignment during a power transfer phase. A Power Transmitter 102 and a Power Receiver 118 may establish a power contract (such as a Guaranteed Power) during a power negotiation 1010. During the power transfer phase 1006, the Power Receiver 118 may communicate power control messages 1020. At block 1030, the Power Transmitter 102 may determine that it is operating at its power limit or that it cannot satisfy the Guaranteed Power at its power limit. For example, the power transfer amount may be reduced due to a misalignment that has occurred after the power negotiation 1010. The misalignment may cause a change in condition that prevents the Power Transmitter from transmitting enough power to satisfy the Guaranteed Power.

At block 1040, the Power Transmitter 102 may initiate a k-factor measurement using any one of a variety of known k-factor determination techniques. At block 1050, the Power Transmitter 102 may determine whether the k-factor is within a threshold range deemed acceptable for power transfer. If the k-factor is outside the threshold range, the Power Transmitter 102 may communicate a warning message 1070 to the Power Receiver 118. The warning message 1070 may prompt a user to re-align the Power Receiver 118 to correct the misalignment. After one or more warning messages 1070 or after a predetermined time during which the misalignment persists, the Power Transmitter 102 may transition (shown at block 1080) out of the power transfer phase 1006 and to a connected phase. In some implementations, at block 1090, the Power Transmitter 102 may communicate a message indicating the misalignment is outside the threshold range that prevents the Power Transmitter 102 from satisfying the requested power level. In some implementations, the Power Transmitter 102 may initiate a new power negotiation or may indicate a fault status.

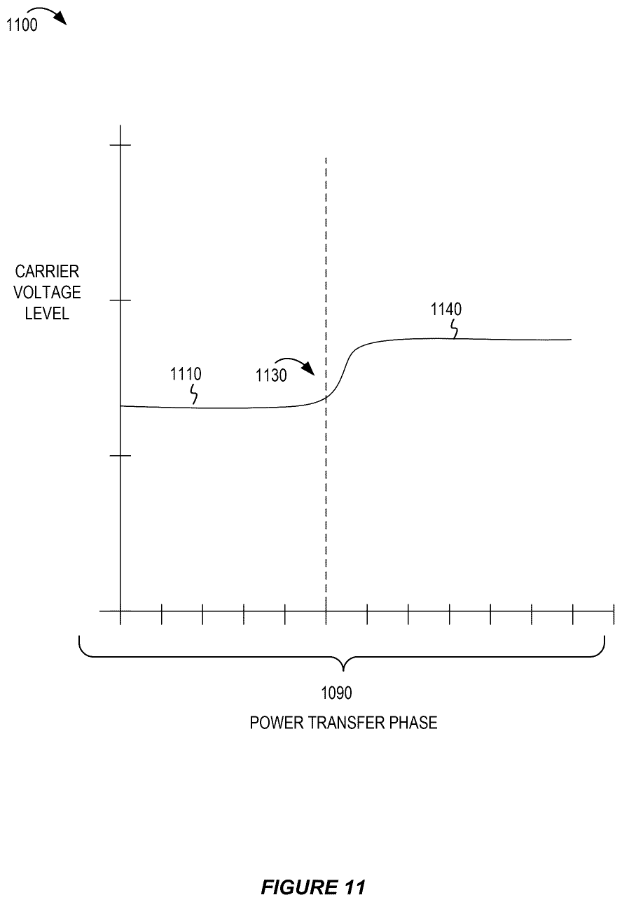

FIG. 11 shows a diagram of a communication carrier voltage value being adjusted during a power transfer phase. In some implementations, the communication carrier value may be a voltage magnitude, peak value, or RMS value of a communication carrier. Traditional wireless power systems require a communication carrier level (such as voltage of an NFC signal) to remain constant during a power transfer phase 1090. However, this may cause loss of communication capability, fidelity of the communication data, or other communication errors, particularly when a misalignment occurs during the power transfer phase.

In accordance with some aspects of this disclosure, a communication carrier level may be adjusted during the power transfer phase 1090. A Power Transmitter may use a first carrier level 1110 at the outset of the power transfer phase 1090. Shown at line 1030, the Power Transmitter may initiate a coupling factor measurement. For example, the Power Transmitter may communicate a command to request the Power Receiver to communicate a measured communication signal voltage. The Power Transmitter may determine the communication coupling has changed and adjust the communication signal to a second communication carrier level 1140. A communication carrier level may refer to a voltage, power, or both. In some implementations, the communication voltage measurement may occur periodically during the power transfer phase 1090. Alternatively, or additionally, the communication coupling factor or voltage measurement may occur in response to detecting a change of the k-factor (power signal coupling factor). Alternatively, or additionally, the communication coupling factor measurement may occur after a threshold quantity of communication errors or non-acknowledgement (NAK) messages from the Power Receiver.

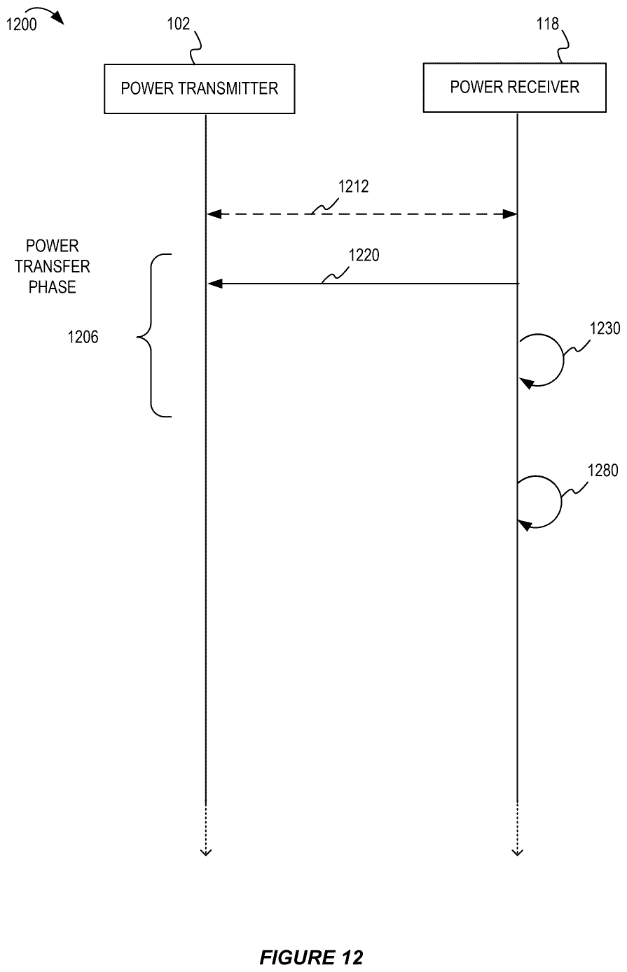

FIG. 12 shows a message flow diagram 1200 conceptually illustrating an example technique for addressing a communication fault during a power transfer phase 1206. A Power Transmitter 102 and a Power Receiver 118 may establish a power contract (such as a Guaranteed Power) during a power negotiation 1212. During the power transfer phase 1206, the Power Receiver 118 may communicate messages 1220 to the Power Transmitter 102. For example, the messages 1220 may be a power control message (such as a CTRL/rpl) or a phase transition message (such as a NEXT/con message). However, the Power Transmitter 102 may not act on the messages 1220 due to a communication error, PTx controller malfunction, or fault condition of the Power Transmitter. At block 1230, the Power Receiver 118 may determine the Power Transmitter 102 is not processing the messages 1220. For example, the Power Receiver 118 may consider the Power Transmitter 102 to be non-responsive to a power control message or a phase transition message.

At block 1280, the Power Receiver 118 may initiate a mitigation technique associated with communication fault of the wireless power system. For example, the Power Receiver 118 may open a protective switch in a power reception circuit of the Power Receiver 118 at an instance of when the alternating current (AC) cycle voltage is near zero (such as during or close to a communication slot). This prevents interruption of a high current that may otherwise cause overvoltage or overcurrent high enough to damage the components of the Power Receiver 118 or the Power Transmitter 102. In some implementations, the Power Receiver 118 may open the protective switch during an instance when the voltage of the AC cycle is below a threshold level to disconnect a secondary coil of the Power Receiver 118 from other components of the power reception circuit. The Power Receiver 118 may harvest basic operating power from the wireless power signal during the communication slot periods. In some implementations, the Power Receiver 118 may present a user interface (UI) indication of the communication fault and power down the Power Receiver 118.

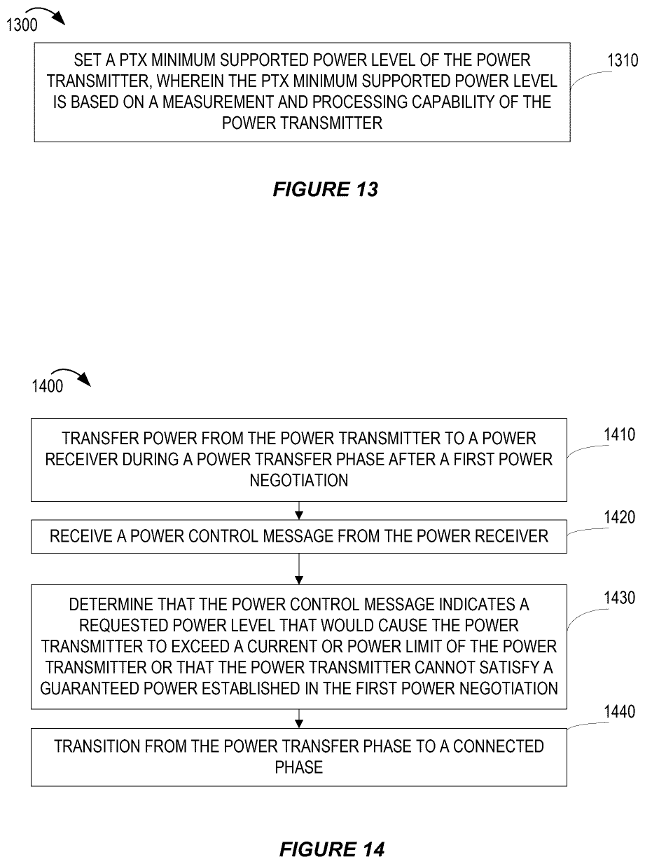

FIG. 13 is a flowchart of an example process 1300. In some implementations, one or more process blocks of FIG. 13 may be performed by a power transmitter.

As shown in FIG. 13, process 1300 may include setting a PTx minimum supported power level of the Power Transmitter, where the PTx minimum supported power level is based on a measurement and processing capability of the Power Transmitter (block 1310). For example, power transmitter may set a PTx minimum supported power level of the power transmitter, where the PTx minimum supported power level is based on a measurement and processing capability of the power transmitter, as described above.

FIG. 14 is a flowchart of an example process 1400. In some implementations, one or more process blocks of FIG. 14 may be performed by a power transmitter.

As shown in FIG. 14, process 1400 may include transferring power from the Power Transmitter to a Power Receiver during a power transfer phase after a first power negotiation (block 1410). For example, power transmitter may transfer power from the power transmitter to a power receiver during a power transfer phase after a first power negotiation, as described above. As also shown in FIG. 14, process 1400 may include receiving a power control message from the Power Receiver (block 1420). For example, power transmitter may receive a power control message from the power receiver, as described above. As further shown in FIG. 14, process 1400 may include determining that the power control message indicates a requested power level that would cause the Power Transmitter to exceed a current or power limit of the Power Transmitter or that the Power Transmitter cannot satisfy a Guaranteed Power established in the first power negotiation (block 1430). For example, power transmitter may determine that the power control message indicates a requested power level that would cause the power transmitter to exceed a current or power limit of the power transmitter or that the power transmitter cannot satisfy a guaranteed power established in the first power negotiation, as described above. As also shown in FIG. 14, process 1400 may include transitioning from the power transfer phase to a connected phase (block 1440). For example, power transmitter may transition from the power transfer phase to a connected phase, as described above.

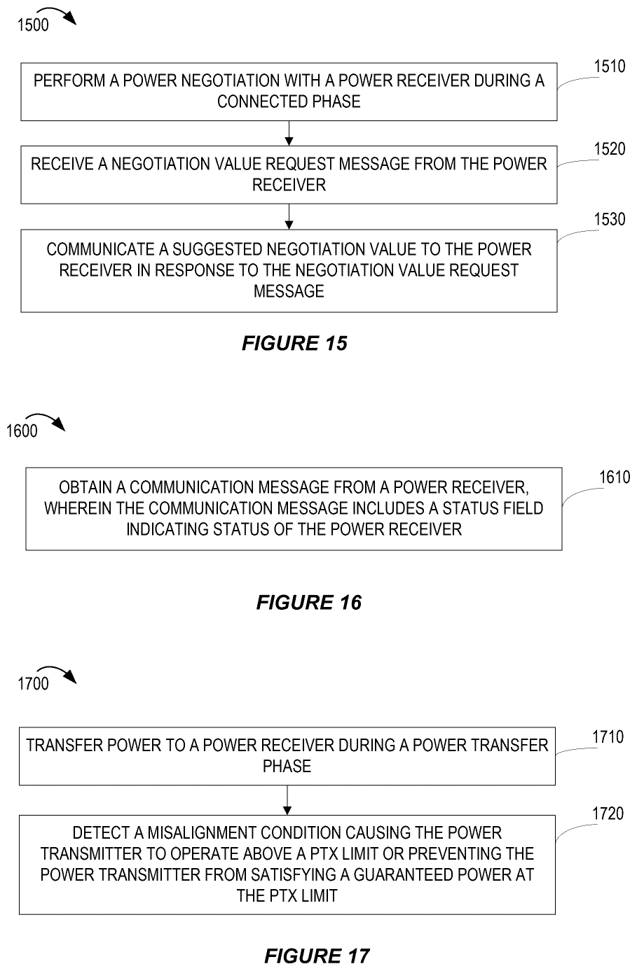

FIG. 15 is a flowchart of an example process 1500. In some implementations, one or more process blocks of FIG. 15 may be performed by a power transmitter.

As shown in FIG. 15, process 1500 may include performing a power negotiation with a Power Receiver during a connected phase (block 1510). For example, power transmitter may perform a power negotiation with a power receiver during a connected phase, as described above. As also shown in FIG. 15, process 1500 may include receiving a negotiation value request message from the Power Receiver (block 1520). For example, power transmitter may receive a negotiation value request message from the power receiver, as described above. As further shown in FIG. 15, process 1500 may include communicating a suggested negotiation value to the Power Receiver in response to the negotiation value request message (block 1530). For example, power transmitter may communicate a suggested negotiation value to the power receiver in response to the negotiation value request message, as described above.

FIG. 16 is a flowchart of an example process 1600. In some implementations, one or more process blocks of FIG. 16 may be performed by a power transmitter.

As shown in FIG. 16, process 1600 may include obtaining a communication message from a Power Receiver, where the communication message includes a status field indicating status of the Power Receiver (block 1610). For example, a power transmitter may obtain a communication message from a power receiver, where the communication message includes a status field indicating status of the power receiver, as described above.

FIG. 17 is a flowchart of an example process 1700. In some implementations, one or more process blocks of FIG. 17 may be performed by a power transmitter.

As shown in FIG. 17, process 1700 may include transferring power to a Power Receiver during a power transfer phase (block 1710). For example, power transmitter may transfer power to a power receiver during a power transfer phase, as described above. As also shown in FIG. 17, process 1700 may include detecting a misalignment condition causing the Power Transmitter to operate above a PTx limit or preventing the Power Transmitter from satisfying a Guaranteed Power at the PTx limit (block 1720). For example, power transmitter may detect a misalignment condition causing the power transmitter to operate above a PTx limit or preventing the power transmitter from satisfying a guaranteed power at the PTx limit, as described above.

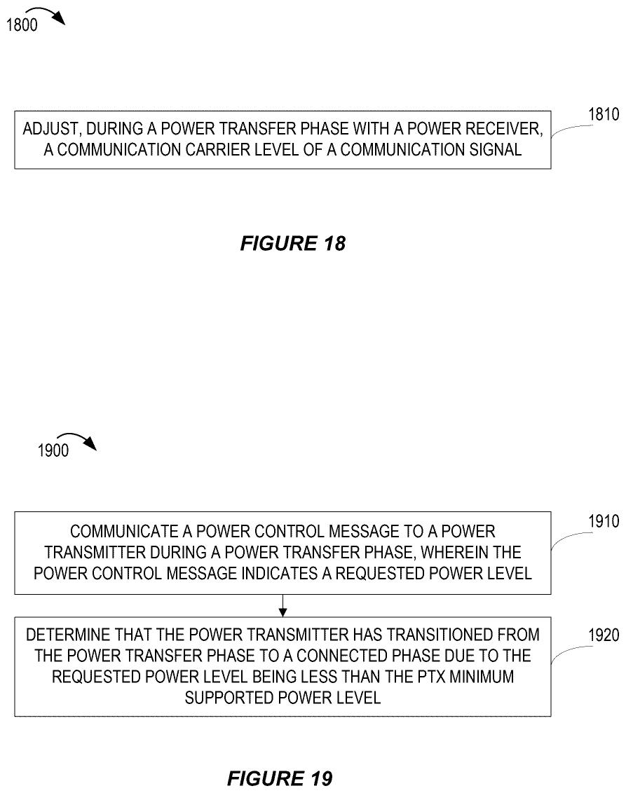

FIG. 18 is a flowchart of an example process 1800. In some implementations, one or more process blocks of FIG. 18 may be performed by a power transmitter.

As shown in FIG. 18, process 1800 may include adjusting, during a power transfer phase with a Power Receiver, a communication carrier level of a communication signal (block 1810). For example, power transmitter may adjust, during a power transfer phase with a power receiver, a communication carrier level of a communication signal, as described above.

FIG. 19 is a flowchart of an example process 1900. In some implementations, one or more process blocks of FIG. 19 may be performed by a power receiver.

As shown in FIG. 19, process 1900 may include communicating a power control message to a Power Transmitter during a power transfer phase, where the power control message indicates a requested power level (block 1910). For example, the power receiver may communicate a power control message to a power transmitter during a power transfer phase, where the power control message indicates a requested power level, as described above. As also shown in FIG. 19, process 1900 may include determining that the Power Transmitter has transitioned from the power transfer phase to a connected phase due to the requested power level being less than the PTx minimum supported power level (block 1920). For example, the power receiver may determine that the power transmitter has transitioned from the power transfer phase to a connected phase due to the requested power level being less than the PTx minimum supported power level, as described above.

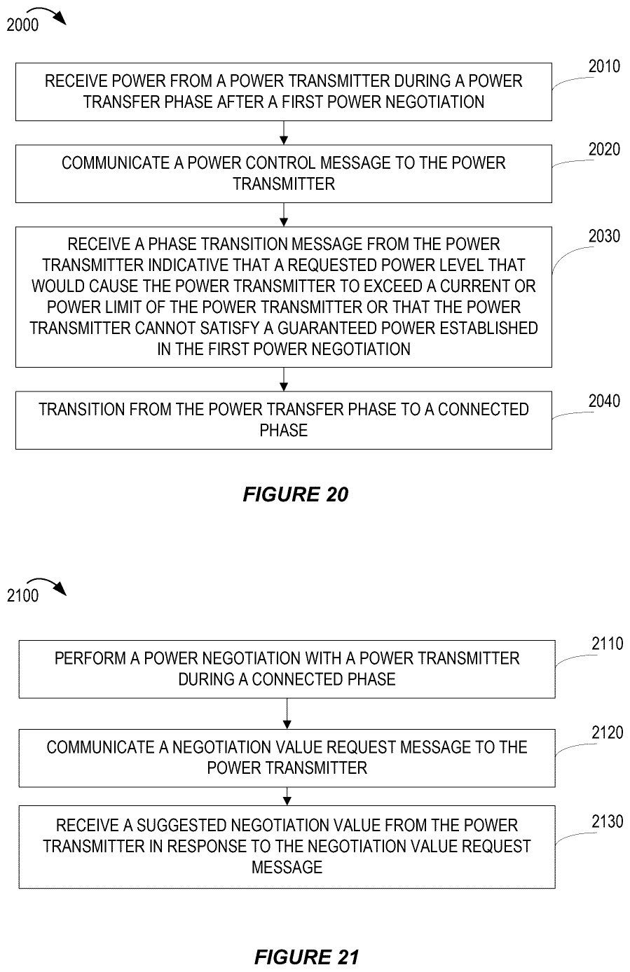

FIG. 20 is a flowchart of an example process 2000. In some implementations, one or more process blocks of FIG. 20 may be performed by a power receiver.

As shown in FIG. 20, process 2000 may include receiving power from a Power Transmitter during a power transfer phase after a first power negotiation (block 2010). For example, a power receiver may receive power from a power transmitter during a power transfer phase after a first power negotiation, as described above. As also shown in FIG. 20, process 2000 may include communicating a power control message to the Power Transmitter (block 2020). For example, the power receiver may communicate a power control message to the power transmitter, as described above. As further shown in FIG. 20, process 2000 may include receiving a phase transition message from the Power Transmitter indicative that a requested power level that would cause the Power Transmitter to exceed a current or power limit of the Power Transmitter or that the Power Transmitter cannot satisfy a Guaranteed Power established in the first power negotiation (block 2030). For example, power receiver may receive a phase transition message from the power transmitter indicative that a requested power level that would cause the power transmitter to exceed a current or power limit of the power transmitter or that the power transmitter cannot satisfy a guaranteed power established in the first power negotiation, as described above. As also shown in FIG. 20, process 2000 may include transitioning from the power transfer phase to a connected phase (block 2040). For example, the power receiver may transition from the power transfer phase to a connected phase, as described above.

FIG. 21 is a flowchart of an example process 2100. In some implementations, one or more process blocks of FIG. 21 may be performed by a power receiver.

As shown in FIG. 21, process 2100 may include performing a power negotiation with a Power Transmitter during a connected phase (block 2110). For example, a power receiver may perform a power negotiation with a power transmitter during a connected phase, as described above. As also shown in FIG. 21, process 2100 may include communicating a negotiation value request message to the Power Transmitter (block 2120). For example, power receiver may communicate a negotiation value request message to the power transmitter, as described above. As further shown in FIG. 21, process 2100 may include receiving a suggested negotiation value from the Power Transmitter in response to the negotiation value request message (block 2130). For example, the power receiver may receive a suggested negotiation value from the power transmitter in response to the negotiation value request message, as described above.

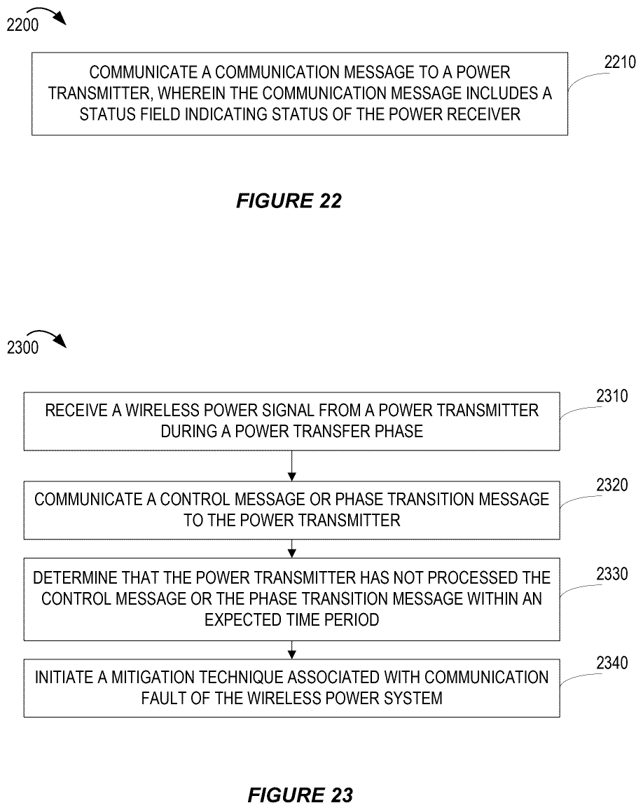

FIG. 22 is a flowchart of example process 2200. In some implementations, one or more process blocks of FIG. 22 may be performed by a power receiver.

As shown in FIG. 22, process 2200 may include communicating a communication message to a Power Transmitter, where the communication message includes a status field indicating status of the Power Receiver (block 2210). For example, power receiver may communicate a communication message to a power transmitter, where the communication message includes a status field indicating status of the power receiver, as described above.

FIG. 23 is a flowchart of an example process 2300. In some implementations, one or more process blocks of FIG. 23 may be performed by a power receiver.

As shown in FIG. 23, process 2300 may include receiving a wireless power signal from a Power Transmitter during a power transfer phase (block 2310). For example, the power receiver may receive a wireless power signal from a power transmitter during a power transfer phase, as described above. As also shown in FIG. 23, process 2300 may include communicating a control message or phase transition message to the Power Transmitter (block 2320). For example, power receiver may communicate a control message or phase transition message to the power transmitter, as described above. As further shown in FIG. 23, process 2300 may include determining that the Power Transmitter has not processed the control message or the phase transition message within an expected time period (block 2330). For example, the power receiver may determine that the power transmitter has not processed the control message or the phase transition message within an expected time period, as described above. As also shown in FIG. 23, process 2300 may include initiating a mitigation technique associated with communication fault of the wireless power system (block 2340). For example, power receiver may initiate a mitigation technique associated with communication fault of the wireless power system, as described above.

Although FIGS. 13-23 show example blocks of processes 1300, 1400, 1500, 1600, 1700, 1800, 1900, 2000, 2100, 2200 and 2300, respectively, in some implementations, processes 1300, 1400, 1500, 1600, 1700, 1800, 1900, 2000, 2100, 2200 and 2300 may include additional blocks, fewer blocks, different blocks, or differently arranged blocks than those depicted in FIGS. 13-23. Additionally, or alternatively, two or more of the blocks of the processes 1300, 1400, 1500, 1600, 1700, 1800, 1900, 2000, 2100, 2200 and 2300 may be performed in parallel.

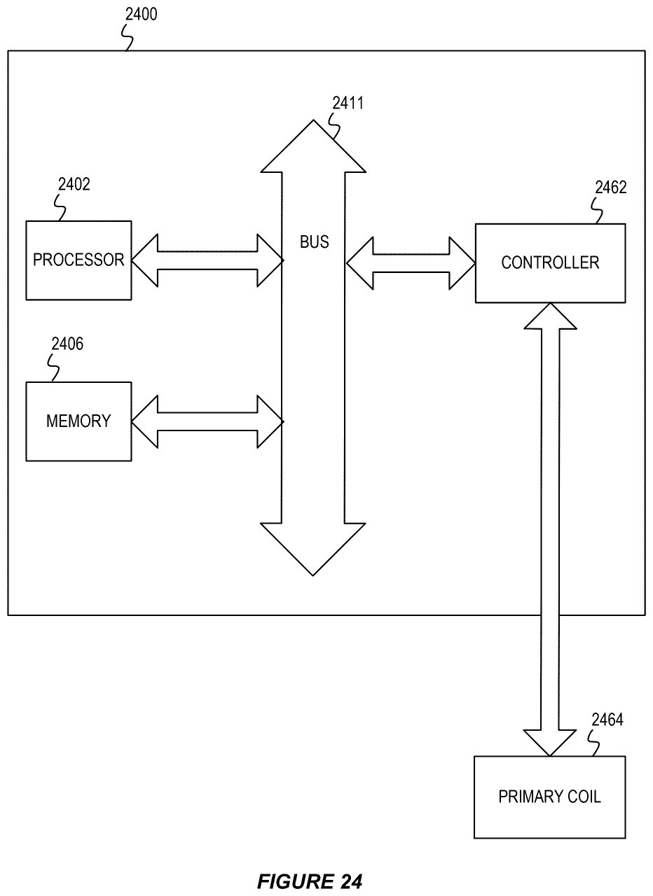

FIG. 24 shows a block diagram of an example apparatus for use in wireless power system. In some implementations, the apparatus 2400 may be a Power Transmitter (such as the Power Transmitter 102) described herein. In some implementations, the apparatus 2400 may be an example of any one of the Power Transmitters 102 or 300, or any one of the TX controllers 108 described with reference to any of the Figures herein. The apparatus 2400 can include a processor 2402 (possibly including multiple processors, multiple cores, multiple nodes, or implementing multi-threading, etc.). The apparatus 2400 also can include a memory 2406. Memory 2406 may be system memory or any one or more of the possible realizations of computer-readable media described herein. The apparatus 2400 also can include a bus 2411 (such as PCI, ISA, PCI-Express, HyperTransport®, InfiniBand®, NuBus, ® AHB, AXI, etc.).

The apparatus 1100 may include one or more controller(s) 2462 configured to manage multiple primary or secondary coils (such as a coil array 2464). In some implementations, the controller(s) 2462 can be distributed within processor 2402, the memory 2406, and the bus 2411. The controller(s) 2462 may perform some or all of the operations described herein. For example, the controller(s) 2462 may be a transmission controller, such as any of the transmission controllers described herein.

The memory 2406 can include computer instructions executable by the processor 2402 to implement the functionality of the implementations described with reference to FIGS. 1-5. Any one of these functionalities may be partially (or entirely) implemented in hardware or on the processor 2402. For example, the functionality may be implemented with an application specific integrated circuit, in logic implemented in the processor 2402, in a co-processor on a peripheral device or card, etc. Further, realizations may include fewer or additional components not illustrated in FIG. 24. The processor 2402, the memory 2406, and the controller(s) 2462 may be coupled to the bus 2411. Although illustrated as being coupled to the bus 2411, the memory 2406 may be coupled to the processor 2402.

FIGS. 1-24 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### Clauses

Clause 1. A method of a Power Transmitter (PTx) in a wireless power system, including: setting a PTx minimum supported power level of the Power Transmitter, where the PTx minimum supported power level is based on a measurement and processing capability of the Power Transmitter.

Clause 2. The method of clause 1, further including: receiving a power control message from a Power Receiver during a power transfer phase; determining that the power control message indicates a requested power level that is less than the PTx minimum supported power level; and transitioning from the power transfer phase to a connected phase.

Clause 3. The method of clause 2, where transitioning from the power transfer phase to the connected phase includes: ending power transfer to the Power Receiver; and communicating a message to cause the Power Receiver to transition to the connected phase.

Clause 4. The method of any one of clauses 1-3, further including: receiving, from the Power Receiver, a configuration value indicating a Power Receiver (PRx) minimum power limit (PRx-min-power) that the Power Receiver will request during the power transfer phase; and verifying that the PRx-min-power is higher than the PTx minimum supported power level.

Clause 5. The method of any one of clauses 1-4, further including: communicating the PTx minimum supported power level to the Power Receiver.

Clause 6. A method of a Power Transmitter (PTx) in a wireless power system, including: transferring power from the Power Transmitter to a Power Receiver during a power transfer phase after a first power negotiation; receiving a power control message from the Power Receiver; determining that the power control message indicates a requested power level that would cause the Power Transmitter to exceed a current or power limit of the Power Transmitter or that the Power Transmitter cannot satisfy a Guaranteed Power established in the first power negotiation; and transitioning from the power transfer phase to a connected phase.

Clause 7. The method of clause 6, where transitioning from the power transfer phase to the connected phase includes: ending power transfer to the Power Receiver; and communicating a message to cause the Power Receiver to transition to the connected phase.

Clause 8. The method of clause 7, further including: initiating a second power negotiation after transitioning to the connected phase, where the second power negotiation includes establishing a second Guaranteed Power to replace the first Guaranteed Power.

Clause 9. The method of clause 8, further including: communicating a suggested power negotiation value during the second power negotiation, where the suggested power negotiation value indicates the second Guaranteed Power that the Power Transmitter can support based on current conditions of the Power Transmitter.

Clause 10. A method of a Power Transmitter (PTx) in a wireless power system, including: performing a power negotiation with a Power Receiver during a connected phase; receiving a negotiation value request message from the Power Receiver; and communicating a suggested negotiation value to the Power Receiver in response to the negotiation value request message.

Clause 11. The method of clause 10, where the suggested negotiation value is based on a Guaranteed Power that the Power Transmitter can guarantee to transfer to the Power Receiver or based on an Available Power of the Power Transmitter.

Clause 12. The method of any one of clauses 10-11, further including: receiving a Requested Power negotiation value from the Power Receiver, where the Requested Power negotiation value is based on the suggested negotiation value.

Clause 13. A method of a Power Transmitter (PTx) in a wireless power system, including: obtaining a communication message from a Power Receiver, where the communication message includes a status field indicating status of the Power Receiver.

Clause 14. The method of clause 13, where the communication message is a measurement (MEAS) message or a request (RQST) message, and where the status field is included in the MEAS or the RQST message.

Clause 15. The method of any one of clauses 13-14, where the status field includes at least one indicator selected from a group consisting of: an indication whether the Power Receiver has wired power available or not; an indication of whether a protective switch is open or closed; and an indication of fault status.

Clause 16. The method of any one of clauses 13-15, where obtaining the communication message includes reading a passive tag of a wireless communication unit of the Power Receiver.

Clause 17. A method of a Power Transmitter (PTx) in a wireless power system, including: transferring power to a Power Receiver during a power transfer phase; and detecting a misalignment condition causing the Power Transmitter to operate above a PTx limit or preventing the Power Transmitter from satisfying a Guaranteed Power at the PTx limit.

Clause 18. The method of clause 17, where detecting the misalignment condition includes: measuring a coupling factor (k-factor) between the Power Transmitter and the Power Receiver; determining that the k-factor is not within a threshold range; and communicating a warning message to the Power Receiver to indicate that the k-factor is outside the threshold range.

Clause 19. The method of clause 18, further including: transitioning to a connected phase in response to detecting the misalignment condition or after the misalignment condition persists for a threshold time.

Clause 20. The method of any one of clauses 17-19, where transitioning from the power transfer phase to the connected phase includes: ending power transfer to the Power Receiver; and communicating a message to cause the Power Receiver to transition to the connected phase.

Clause 21. The method of any one of clauses 17-20, where detecting the misalignment condition includes: verifying that no power transmission faults have been indicated or identified by the Power Receiver or Power Receiver that would cause the Power Transmitter to operate above the PTx limit or prevent the Power Transmitter from satisfying the Guaranteed Power at the PTx limit; and detecting the misalignment condition when a coupling factor (k-factor) is outside a threshold range and no power transmission faults have been indicated or identified.

Clause 22. A method of a Power Transmitter (PTx) in a wireless power system, including: adjusting, during a power transfer phase with a Power Receiver, a communication carrier level of a communication signal.

Clause 23. The method of clause 22, further including, during the power transfer phase: obtaining a measurement value from the Power Receiver, the measurement value indicating a measured voltage level of the communication signal received by the Power Receiver; and adjusting the communication carrier level based on the measurement value.

Clause 24. The method of any one of clauses 22-23, further including: detecting a change in alignment between a first communication unit of the Power Transmitter and a second communication unit of the Power Receiver; and adjusting the communication carrier level based on the change in alignment.

Clause 25. A Power Transmitter, including: a controller configured to perform any one of the methods of clauses 1-24.

Clause 26. A method of a Power Receiver (PRx) in a wireless power system, including: communicating a power control message to a Power Transmitter during a power transfer phase, where the power control message indicates a requested power level; and determining that the Power Transmitter has transitioned from the power transfer phase to a connected phase due to the requested power level being less than the PTx minimum supported power level.

Clause 27. The method of clause 26, further including: communicating, from the Power Receiver to the Power Transmitter, a configuration value indicating a PRx minimum power limit (PRx-min-power) that the Power Receiver will request during the power transfer phase.

Clause 28. The method of any one of clauses 26-27, further including: receiving a communication from the Power Transmitter indicating the PTx minimum supported power level.

Clause 29. A method of a Power Receiver (PRx) in a wireless power system, including: receiving power from a Power Transmitter during a power transfer phase after a first power negotiation; communicating a power control message to the Power Transmitter; receiving a phase transition message from the Power Transmitter indicative that a requested power level that would cause the Power Transmitter to exceed a current or power limit of the Power Transmitter or that the Power Transmitter cannot satisfy a Guaranteed Power established in the first power negotiation; and transitioning from the power transfer phase to a connected phase.

Clause 30. The method of clause 32, further including: initiating a second power negotiation after transitioning to the connected phase, where the second power negotiation includes establishing a second Guaranteed Power to replace the first Guaranteed Power.

Clause 31. The method of clause 30, further including: receiving a suggested power negotiation value from the Power Transmitter during the second power negotiation, where the suggested power negotiation value indicates the second Guaranteed Power that the Power Transmitter can support based on current conditions of the Power Transmitter.

Clause 32. A method of a Power Receiver (PRx) in a wireless power system, including: performing a power negotiation with a Power Transmitter during a connected phase; communicating a negotiation value request message to the Power Transmitter; and receiving a suggested negotiation value from the Power Transmitter in response to the negotiation value request message.

Clause 33. The method of clause 32, where the suggested negotiation value is based on a Guaranteed Power that the Power Transmitter can guarantee to transfer to the Power Receiver or based on an Available Power of the Power Transmitter.

Clause 34. The method of any one of clauses 32-33, further including: Communicating a Requested Power negotiation value from the Power Receiver, where the Requested Power negotiation value is based on the suggested negotiation value.

Clause 35. A method of a Power Receiver (PRx) in a wireless power system, including: communicating a communication message to a Power Transmitter, where the communication message includes a status field indicating status of the Power Receiver.

Clause 36. The method of clause 35, where the communication message is a measurement (MEAS) message or a request (RQST) message, and where the status field is included in the MEAS or the RQST message.

Clause 37. The method of any one of clauses 35-36, where the status field includes at least one indicator selected from a group consisting of: an indication whether the Power Receiver has wired power available or not; an indication of whether a protective switch is open or closed; and an indication of fault status.

Clause 38. The method of any one of clauses 35-37, where communicating the communication message includes storing the communication message in a passive tag of a wireless communication unit of the Power Receiver, such that the communication message can be read by a corresponding communication unit of the Power Transmitter.

Clause 39. A method of a Power Receiver (PRx) in a wireless power system, including: receiving a wireless power signal from a Power Transmitter during a power transfer phase; communicating a control message or phase transition message to the Power Transmitter; determining that the Power Transmitter has not processed the control message or the phase transition message within an expected time period; and initiating a mitigation technique associated with communication fault of the wireless power system.

Clause 40. The method of clause 39, where the mitigation technique includes: opening a protective switch in a power reception circuit of the Power Receiver during at last part of an alternating current (AC) cycle of the wireless power signal.

Clause 41. The method of clause 40, where the mitigation technique includes: opening the protective switch during a period in which the voltage of the AC cycle is below a threshold level to disconnect a secondary coil of the Power Receiver from other components of the power reception circuit; and harvesting basic operating power from the wireless power signal or a communication signal during the communication periods in which communication between Power Transmitter and Power Receiver happens.

Clause 42. The method of any one of clauses 39-41, where the mitigation technique includes: presenting a user interface (UI) indication of the communication fault; and powering down the Power Receiver.

Clause 43. A Power Receiver, including: a controller configured to perform any one of the methods of clauses 26-42.

Another innovative aspect of the subject matter described in this disclosure can be implemented as an apparatus. The apparatus may include a modem and at least one processor communicatively coupled with the modem. The processor, in conjunction with the modem, may be configured to perform any one of the above-mentioned methods or features described herein.

Another innovative aspect of the subject matter described in this disclosure can be implemented as a computer-readable medium having stored therein instructions which, when executed by a processor, causes the processor to perform any one of the above-mentioned methods or features described herein.

Another innovative aspect of the subject matter described in this disclosure can be implemented as a system having means for implementing any one of the above-mentioned methods or features described herein.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method of a Power Transmitter (PTx) in a wireless power system, the method comprising:
performing a first power negotiation with a Power Receiver before a power transfer phase;
communicating a suggested negotiation value to the Power Receiver as part of the first power negotiation;
receiving a Requested Power negotiation value from the Power Receiver, wherein the Requested Power negotiation value is based on the suggested negotiation value; and
indicating that the Power Transmitter accepts the Requested Power negotiation value; and
establishing a first Guaranteed Power based on acceptance of the Requested Power negotiation value.

2. The method of claim 1, wherein the suggested negotiation value is based on a highest Guaranteed Power that the Power Transmitter can negotiate with the Power Receiver based on prevailing operating conditions of the Power Transmitter.

3. The method of claim 1, further comprising:
receiving a negotiation value request message from the Power Receiver; and
communicating the suggested negotiation value to the Power Receiver in response to the negotiation value request message.

4. The method of claim 1, further comprising:
transferring power from the Power Transmitter to the Power Receiver during a power transfer phase after the first power negotiation;
receiving a power control message from the Power Receiver, the power control message indicating a requested power level;
determining that the requested power level would cause the Power Transmitter to exceed a current or power limit of the Power Transmitter or that the Power Transmitter cannot satisfy the first Guaranteed Power established in the first power negotiation; and
initiating a second power negotiation to establish a second Guaranteed Power to replace the first Guaranteed Power.

5. The method of claim 4, wherein initiating the second power negotiation includes:
ending power transfer to the Power Receiver; and
communicating a message to cause the Power Receiver to transition from the power transfer phase to a connected phase.

6. The method of claim 4, further comprising:
communicating a new suggested power negotiation value during the second power negotiation, wherein the new suggested power negotiation value indicates the second Guaranteed Power that the Power Transmitter can support based on current operating conditions of the Power Transmitter.

7. The method of claim 1, further comprising:
transferring power to the Power Receiver during the power transfer phase;
detecting, based on measurements at the Power Transmitter, that a misalignment condition is causing the Power Transmitter to operate above a PTx limit or preventing the Power Transmitter from satisfying the first Guaranteed Power at the PTx limit; and
communicating a warning message to indicate the misalignment condition.

8. The method of claim 7, wherein detecting the misalignment condition includes:
measuring a coupling factor (k-factor) between the Power Transmitter and the Power Receiver; and
determining that the k-factor is not within a threshold range.

9. The method of claim 7, further comprising:
ending power transfer to the Power Receiver; and
transitioning to a connected phase in response to detecting the misalignment condition or after the misalignment condition persists for a threshold time.

10. The method of claim 7, wherein detecting the misalignment condition includes:
verifying that no power transmission faults have been indicated or identified by the Power Receiver or Power Receiver that would cause the Power Transmitter to operate above the PTx limit or prevent the Power Transmitter from satisfying the Guaranteed Power at the PTx limit; and
detecting the misalignment condition when a coupling factor (k-factor) is outside a threshold range and no power transmission faults have been indicated or identified.

11. The method of claim 1, further comprising:
receiving a communication message from the Power Receiver, the communication message including a status field indicating status of the Power Receiver, wherein the status field includes at least one indicator selected from a group consisting of:
an indication whether the Power Receiver has wired power available or not;
an indication of whether a protective switch is open or closed; and
an indication of fault status.

12. The method of claim 11, wherein the communication message is a measurement (MEAS) message or a request (RQST) message, and wherein the status field is included in the MEAS or the RQST message.

13. The method of claim 1, further comprising:
adjusting, during the power transfer phase, a communication carrier level of a communication signal.

14. The method of claim 13, further comprising, during the power transfer phase:
obtaining a value from the Power Receiver, the value indicating a measured voltage level of the communication signal received by the Power Receiver; and
adjusting the communication carrier level based on the value.

15. The method of claim 13, further comprising:
detecting a change in alignment between a first communication unit of the Power Transmitter and a second communication unit of the Power Receiver; and
adjusting the communication carrier level based on the change in alignment.

16. (canceled)

17. A method of a Power Receiver (PRx) in a wireless power system, comprising:
performing a first power negotiation with a Power Transmitter before a power transfer phase;
receiving a suggested negotiation value from the Power Transmitter as part of the first power negotiation, wherein the suggested negotiation value is based on a first Guaranteed Power that the Power Transmitter can guarantee to transfer to the Power Receiver or based on an Available Power of the Power Transmitter;
communicating a Requested Power negotiation value to the Power Transmitter, wherein the Requested Power negotiation value is based on the suggested negotiation value; and
receiving an indication that the Power Transmitter accepts the Requested Power negotiation value.

18. (canceled)

19. The method of claim 17, further comprising:
communicating a negotiation value request message to the Power Transmitter; and
receiving the suggested negotiation value from the Power Transmitter in response to the negotiation value request message, wherein the suggested negotiation value is based on a Guaranteed Power that the Power Transmitter can guarantee to transfer to the Power Receiver or based on an Available Power of the Power Transmitter.

20. The method of claim 17, further comprising:
receiving power from the Power Transmitter during the power transfer phase after the first power negotiation;
communicating a power control message to the Power Transmitter, the power control message indicating a requested power level;
receiving a message from the Power Transmitter initiating a second power negotiation to establish a second Guaranteed Power to replace the first Guaranteed Power; and
receiving a new suggested power negotiation value from the Power Transmitter as part of the second power negotiation.

21. (canceled)

22. The method of claim 17, further comprising:
receiving power from the Power Transmitter during the power transfer phase;
communicating a control message or phase transition message to the Power Transmitter;
detecting a communication fault when the Power Transmitter has not processed the control message or the phase transition message within an expected time period; and
initiating a mitigation technique associated with the communication fault, wherein the mitigation technique includes at least one of:
presenting a user interface (UI) indication of the communication fault,
powering down the Power Receiver,
opening a protective switch in a power reception circuit of the Power Receiver to disconnect a secondary coil of the Power Receiver from other components of the power reception circuit,
opening the protective switch during a period in which a voltage of an alternating current (AC) cycle of a wireless power signal is below a threshold level; and
harvesting basic operating power from the wireless power signal or a communication signal during communication periods in which communication between Power Transmitter and Power Receiver happens.

23-26. (canceled)

27. An apparatus, comprising:
a communication unit; and
a controller to operate the communication unit to:
perform a first power negotiation before a power transfer phase;
communicate a suggested negotiation value of a Power Transmitter as part of the first power negotiation, wherein the suggested negotiation value is based on a Guaranteed Power that the Power Transmitter can guarantee to transfer to the Power Receiver or based on an Available Power of the Power Transmitter;
communicate a Requested Power negotiation value of the Power Receiver, wherein the Requested Power negotiation value is based on the suggested negotiation value; and
communicate an indication that the Power Transmitter accepts the Requested Power negotiation value.

28. The apparatus of claim 27, wherein the controller operates the communication unit to:
communicate a communication message including a status field indicating status of the Power Receiver, wherein the status field includes at least one indicator selected from a group consisting of:
an indication whether the Power Receiver has wired power available or not;
an indication of whether a protective switch is open or closed; and
an indication of fault status.

29. The apparatus of claim 27, wherein the controller operates the communication unit to:
communicate a control message or phase transition message from the Power Receiver to the Power Transmitter;
detect a communication fault when the Power Transmitter has not processed the control message or the phase transition message within an expected time period; and
initiate a mitigation technique associated with the communication fault.
